(19) United States
(12) Patent Application Publication
(10) Pub. No.: US 2026/0182694 A1
(43) Pub. Date: Jul. 2, 2026

(54) Wearable Hydraulic System And Shock Absorbing Device For Reducing Forces Due To Impact

(71) Applicant: Savior Brain Inc., Arlington, VA (US)

(72) Inventors: Benjamin John MEUNIER, San Clemente, CA (US); Quin Fitzgerald GAUGHAN, Elmhurst, IL (US); Kyle James CASAZZA, Middletown, NJ (US); Ashwin GANESHAN, Alexandria, VA (US); Nicholas James CECCHI, Fairfax, VA (US); Gordon Lee AVERY, JR., Arlington, VA (US)

(21) Appl. No.: 19/461,511

(22) Filed: Jan. 27, 2026

Related U.S. Application Data
(63) Continuation-in-part of application No. 18/221,107, filed on Jul. 12, 2023.
(60) Provisional application No. 63/368,158, filed on Jul. 12, 2022.
(60) Provisional application No. 63/750,563, filed on Jan. 28, 2025.
(60) Provisional application No. 63/887,964, filed on Sep. 25, 2025.

(51) Int. Cl. A42B 3/12; F16F 9/14

(52) U.S. Cl. CPC A42B 3/121; F16F 9/14; F16F 2222/12; F16F 2232/08; F16F 2236/045

(57) ABSTRACT

A shock absorbing device includes a first contiguous membrane and a second contiguous membrane surrounding the first contiguous membrane. The first contiguous membrane defines a primary liquid reservoir containing a liquid. The first contiguous membrane includes at least one collapsible feature. The second contiguous membrane defines a secondary liquid reservoir fluidly connected to the primary liquid reservoir through an orifice. The second contiguous membrane is impermeable. In a first state, the first contiguous membrane is in a first expanded position. In a second state, the first contiguous membrane is in a second compressed position. The first contiguous membrane is compressible upon an impact thereby transferring the liquid from the primary liquid reservoir through the orifice to the secondary liquid reservoir and dissipating the impact.

### CROSS-REFERENCE TO RELATED APPLICATIONS

This application is a continuation-in-part of U.S. patent application Ser. No. 18/221,107 filed on Jul. 12, 2023, which claims priority to U.S. Provisional Application No. 63/368,158 filed on Jul. 12, 2022. This application claims the benefit of U.S. Provisional Application No. 63/750,563, filed on Jan. 28, 2025, and U.S. Provisional Application No. 63/887,964, filed on Sep. 25, 2025. The entire disclosures of each of the above applications are incorporated herein by reference.

### STATEMENT OF GOVERNMENT RIGHTS

This invention was made with government support under R43 NS119134 and R44 NS119134 awarded by National Institutes of Health. The government has certain rights in the invention.

### FIELD

The present disclosure relates to a wearable hydraulic system and shock absorbing device. The hydraulic system and shock absorbing device may provide impact protection for people and goods engaged in various activities and professions including athletics, transportation, military and first responders and industrial activities.

### BACKGROUND

This section provides background information related to the present disclosure which is not necessarily prior art.

Generally, impacts to a person (e.g., a human body), articles (e.g., sporting equipment, machinery, devices, etc.), and/or structures (e.g., buildings) may cause undesired damage or injury to the person, article, and/or structure. Protective equipment (e.g., helmets, padding, etc.), may be utilized to reduce the force of impact from an impact source (e.g., another person, a ball, a piece of equipment, etc.).

Traditional methods of impact force mitigation have relied on the compression of stiff, closed-cell polymer foams, such as expanded polystyrene (EPS) and expanded polypropylene (EPP). Modem variants now include structures utilizing viscoelastic foams and rubbers. The traditional “stiff” materials are effective at passing regulatory body certification testing and preventing catastrophic skull fracture injury at high energy impacts but offer little attenuation of impacts of medium energy. Viscoelastic foams and rubbers may offer better performance over a larger range of impact energies but often have dramatically reduced efficacy in real-world applications where temperature extremes and environmental exposure reduce their performance.

It is desirable to utilize a hydraulic system and shock absorbing device that reduces the forces transmitted to a person or article exposed to impact. It is desirable to reduce forces transmitted through protective articles such as helmets and body padding. It is further desirable for the protective articles to provide automatic adjustment for fit and comfort, especially when the protective articles are wearable.

Some shock absorbing devices use the entire physically available stroke at the minimum, constant force required for dissipation of the impact energy of a given event, or the full range of applicable use temperatures. It is desirable to utilize liquid-based shock absorbing technology to provide a consistent force response. Further, it is desirable to provide a consistent force response that scales with impact energy. It is also desirable to provide a shock absorbing device that has minimal performance variation over a broad range of use temperatures.

Some hydraulic shock absorbers are designed from rigid, heavy metal pistons. These designs may attenuate impact energy. However, a maximum stroke of these designs is limited to only half of their total height, which limits their ability to efficiently reduce impact forces and dissipate impact energy in confined spaces. It is desirable for a hydraulic shock absorber to attenuate impact forces across a stroke length that is greater than 50% of its total height, while also being able to restore itself to its original height for another impact. It is further desirable for a hydraulic shock absorber to include collapsible features to enable a greater use of total height as stroke upon impact.

### SUMMARY

This section provides a general summary of the disclosure, and is not a comprehensive disclosure of its full scope or all of its features.

In one form, the present disclosure provides a shock absorbing device. The shock absorbing device includes a first contiguous membrane and a second contiguous membrane. The first contiguous membrane defines a primary liquid reservoir containing a liquid. The first contiguous membrane includes at least one collapsible feature. The second contiguous membrane surrounds the first contiguous membrane. The second contiguous membrane defines a secondary liquid reservoir fluidly connected to the primary liquid reservoir through an orifice. The second contiguous membrane is impermeable. In a first state, the first contiguous membrane is in a first expanded position. In a second state, the first contiguous membrane is in a second compressed position. The first contiguous membrane is compressible upon an impact thereby transferring liquid from the primary liquid reservoir through the orifice to the secondary liquid reservoir and dissipating the impact.

In some configurations of the shock absorbing device of the above paragraph, the first contiguous membrane is configured to resist circumferential expansion upon an impact.

In some configurations of the shock absorbing device of any of the above paragraphs, the second contiguous membrane has a degree of freedom relative to a first wall of the first contiguous membrane.

In some configurations of the shock absorbing device of any of the above paragraphs, the second contiguous membrane is configured to reversibly deform upon an impact.

In some configurations of the shock absorbing device of any of the above paragraphs, the first contiguous membrane and the second contiguous membrane cooperate to dissipate an impact in an axial direction and a tangential direction.

In some configurations of the shock absorbing device of any of the above paragraphs, the first contiguous membrane is reversibly compressible between the first state and the second state.

In some configurations of the shock absorbing device of any of the above paragraphs, the at least one collapsible feature is a plurality of bellows.

In some configurations of the shock absorbing device of any of the above paragraphs, each of the bellows includes a first wall and a second wall extending at an angle relative to a plane of the bellows that is greater than or equal to about 100 degrees to less than or equal to about 160 degrees.

In some configurations of the shock absorbing device of any of the above paragraphs, the at least one collapsible feature is a plurality of discrete steps.

In some configurations of the shock absorbing device of any of the above paragraphs, each of the discrete steps includes an axially extending wall and an angled wall. The angled wall connects a first axially extending wall of a first step and a second axially extending wall of a second step. A first diameter defined by the first axially extending wall is greater than a second diameter defined by the second axially extending wall.

In some configurations of the shock absorbing device of any of the above paragraphs, each of the angled walls extend at an angle that is greater than or equal to about 10 degrees to less than or equal to about 80 degrees.

In some configurations of the shock absorbing device of any of the above paragraphs, the first contiguous membrane includes a first wall, a side wall, and a base wall. A first thickness of the side wall adjacent the base wall is greater than a second thickness of the side wall adjacent the first wall.

In some configurations of the shock absorbing device of any of the above paragraphs, the at least one collapsible feature is a buckle point positioned between the first wall and the base wall. A first portion of the side wall is configured to collapse and a second portion of the side wall is not configured to collapse.

In some configurations of the shock absorbing device of any of the above paragraphs, the shock absorbing device further includes a plate adjacent to a first wall of the first contiguous membrane. The plate is configured to absorb at least a portion of the impact.

In one form, the present disclosure provides a shock absorbing device. The shock absorbing device includes a first contiguous membrane, a second contiguous membrane, and an exterior sleeve surrounding the first contiguous membrane and the second contiguous membrane. The first contiguous membrane defines a first primary liquid reservoir containing a liquid. The first contiguous membrane includes at least one collapsible feature. The second contiguous membrane surrounds the first contiguous membrane. The second contiguous membrane defines a first secondary liquid reservoir fluidly connected to the primary liquid reservoir through a first orifice. The second contiguous membrane is impermeable. In a first state, the first contiguous membrane is in a first expanded position. In a second state, the first contiguous membrane is in a second compressed position. The first contiguous membrane is compressible upon an impact thereby transferring liquid from the primary liquid reservoir through the orifice to the secondary liquid reservoir and dissipating the impact.

In some configurations of the shock absorbing device of the above paragraph, the shock absorbing device further includes a support structure disposed between the second contiguous membrane and the exterior sleeve. The support structure defines an aperture therethrough. The second contiguous membrane is at least partially received in the aperture.

In some configurations of the shock absorbing device of any of the above paragraphs, the shock absorbing device further includes a plate disposed between the second contiguous membrane and the exterior sleeve. The plate is configured to transfer impact energy to the first contiguous membrane.

In some configurations of the shock absorbing device of any of the above paragraphs, the shock absorbing device further includes a plate disposed between the first contiguous membrane and the second contiguous membrane. The plate is configured to transfer impact energy to the first contiguous membrane.

In some configurations of the shock absorbing device of any of the above paragraphs, the at least one collapsible feature is (i) a plurality of bellows, (ii) a plurality of discrete steps, or (iii) a buckle point of the first contiguous membrane.

In some configurations of the shock absorbing device of any of the above paragraphs, the shock absorbing device further includes a third contiguous membrane and a fourth contiguous membrane. The third contiguous membrane defines a second primary liquid reservoir containing a liquid. The third contiguous membrane includes at least one collapsible feature. The third contiguous membrane is compressible from an expanded state and a compressed state. The fourth contiguous membrane surrounds the third contiguous membrane. The fourth contiguous membrane defines a second secondary liquid reservoir fluidly connected to the second primary liquid reservoir through a second orifice. A plate is disposed within the exterior sleeve and is configured to transfer an impact load to both the first contiguous membrane and the third contiguous membrane. The third contiguous membrane is compressible upon impact thereby transferring the liquid from the second primary liquid reservoir through the second orifice to the second secondary liquid reservoir and dissipating the impact. The exterior sleeve surround the third contiguous membrane and the fourth contiguous membrane.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIGS. 1A-1C illustrate a cross-section showing the basic function of an individual hydraulic shock absorbing device during impact according to the present disclosure;

FIG. 2 illustrates a cross-section of the shock absorbing device in the uncompressed state according to the present disclosure;

FIG. 3 illustrates a cross-section of the shock absorbing device in the collapsed state according to the present disclosure;

FIG. 4 illustrates a cross-section of another embodiment of the shock absorbing device having a conical coil spring to create liquid return pressure according to the present disclosure;

FIG. 5 illustrates a cross-section of another embodiment of the shock absorbing device having flexible spring fingers to create liquid return pressure according to the present disclosure. ;

FIG. 6 illustrates a cross-section of yet another embodiment of the shock absorbing device having a low density open-cell foam (i.e., “reticulated foam”) used to create spring-like liquid return pressure according to the present disclosure;

FIG. 7 illustrates a cross-section of another embodiment of a shock absorbing device with low to medium density foam externally laminated to create spring-like liquid return pressure according to the present disclosure;

FIG. 8 illustrates a cross-section of another embodiment of the shock absorbing device with medium to high density foam or rubber externally adhered to a primary liquid reservoir fabric to create spring-like liquid return pressure according to the present disclosure;

FIG. 9 illustrates a cross-section of yet another embodiment of the shock absorbing device with plastic spring fingers applying force externally to the liquid collection reservoir o create liquid return pressure according to the present disclosure;

FIG. 10 illustrates a cross-section of an embodiment of an orifice ring with integrated collapsing structure for added shock absorption at the end of the liquid stroke according to the present disclosure;

FIG. 11 illustrates a cross-section of an embodiment of a shock absorbing device having double height with formed chambers on both top and bottom of the device according to the present disclosure;

FIGS. 12A-12B illustrate a shock absorbing device utilizing pressure-activated, progressively adaptive orifice ports according to the present disclosure;

FIGS. 13A-13D illustrate a shock absorbing device utilizing sequential collection reservoirs to increase energy absorption according to the present disclosure. As the primary liquid chamber begins to compress (A), the liquid enters the first of the sequential reserves and it begins to inflate (B), until both the first and second reservoirs are at the same height (C) at which point both reservoirs continue to absorb impact and force liquid into additional reservoirs until all are equal height (D);

FIG. 14 illustrates an embodiment for reduced system mass applications of the present shock absorbing devices according to the present disclosure;

FIG. 15 illustrates a shock absorbing device in use in a football helmet according to the present disclosure;

FIGS. 16A-16E illustrate an array of shock absorbing devices employed to absorb shock in a helmet construction according to the present disclosure;

FIGS. 17A-17H illustrates an array of multiple shock absorbing devices sharing a common collection reservoir and how these may be utilized in various arrangements to cover various regions on a human head;

FIGS. 18A-18D illustrate another embodiment of a shock absorbing device wherein the liquid in the primary reservoir is enclosed in a fully sealed container and on impact of predetermined force or greater, the container is ruptured releasing the enclosed fluid, allowing it to flow;

FIG. 19 illustrates yet another embodiment of a shock absorbing device having a series of interconnected primary and secondary collection reservoirs;

FIG. 20 illustrates a cross section A-A of the shock absorbing device of FIG. 19;

FIG. 21 illustrates a three-dimensional view of the shock absorbing device of FIG. 19;

FIGS. 22A-22B illustrate a cross section of a shock absorbing device;

FIGS. 23A-23C illustrate an exemplary collapsible contiguous membrane of a shock absorbing device;

FIGS. 24A-24B illustrate a cross section of a shock absorbing device;

FIGS. 25A-25C illustrate a padding assembly including the shock absorbing device of FIGS. 22A-22B;

FIGS. 26A-26B illustrate a helmet including the padding assembly of FIGS. 25A-25C;

FIG. 26C is a graph showing impact versus linear acceleration of a helmet including the shock absorbing device according to aspects of the present disclosure;

FIG. 27 illustrates another helmet including a padding assembly including a shock absorbing device;

FIG. 28 illustrates another helmet including a padding assembly including a shock absorbing device;

FIGS. 29A-29B illustrate another padding assembly including a shock absorbing device;

FIGS. 30A-30E illustrate padding assemblies including a shock absorbing device;

FIG. 31 illustrates another padding assembly including two shock absorbing devices;

FIGS. 32A-32B illustrate another shock absorbing device;

FIGS. 33A-33B illustrate a contiguous membrane of the shock absorbing device of FIGS. 32A-32B;

FIGS. 34A-34C are force versus displacement plots of exemplary shock absorbing devices under an impact;

FIGS. 35A-35D illustrate another shock absorbing device;

FIG. 36 illustrates another shock absorbing device;

FIGS. 37A-37B illustrate another padding assembly including two shock absorbing devices;

FIGS. 38A-38B illustrate another shock absorbing device; and

FIG. 39 illustrates another padding assembly including a shock absorbing device.

Corresponding reference numerals indicate corresponding parts throughout the several views of the drawings.

### DETAILED DESCRIPTION

Example embodiments will now be described more fully with reference to the accompanying drawings.

The present disclosure relates to a hydraulic system and shock absorbing device for reducing the forces transmitted to a person or item exposed to impact. The present disclosure also relates to a liquid-filled comfort and fit device, which is useful in wearable articles such as helmets. The liquid-filled device adjusts to the size and shape of the user's head, thereby providing a better, more comfortable fit when incorporated into a wearable item.

Hydraulic shock absorbers have been used for decades to reduce the forces transmitted during impacts. In a classic liquid shock absorber, an incompressible liquid is contained in a cylinder reservoir and a piston with small orifices is pushed through the liquid reservoir during an impact event. Energy is dissipated as the liquid squeezes through the orifices at high pressure. After the impact, the shock resets, typically by aid of an external spring that pushes the piston into its uncompressed state while check valves in the piston head allow for liquid to easily return to the reservoir.

A limitation to traditional shock absorbers is that the available stroke can never be more than half the total length of the uncompressed system. Another limitation is the systems are typically constructed of heavy, rigid materials that limit their application for body-worn protection.

The present hydraulic system described herein is a soft hydraulic shock absorbing device that maximizes available energy absorption stroke through the use of strong flexible materials and flexible collection reservoirs. Potential applications for this technology are numerous and include wearable protective gear such as helmets, body padding and armor as well as many automotive and electronic protection systems, and/or anything that may be deemed fragile and/or high value. Additionally, the present device is useful as a comfort and fit device when incorporated into wearable items such as helmets or other forms of adjustable body padding because the fluid-filled nature of the device permits it to accommodate various configurations of the user.

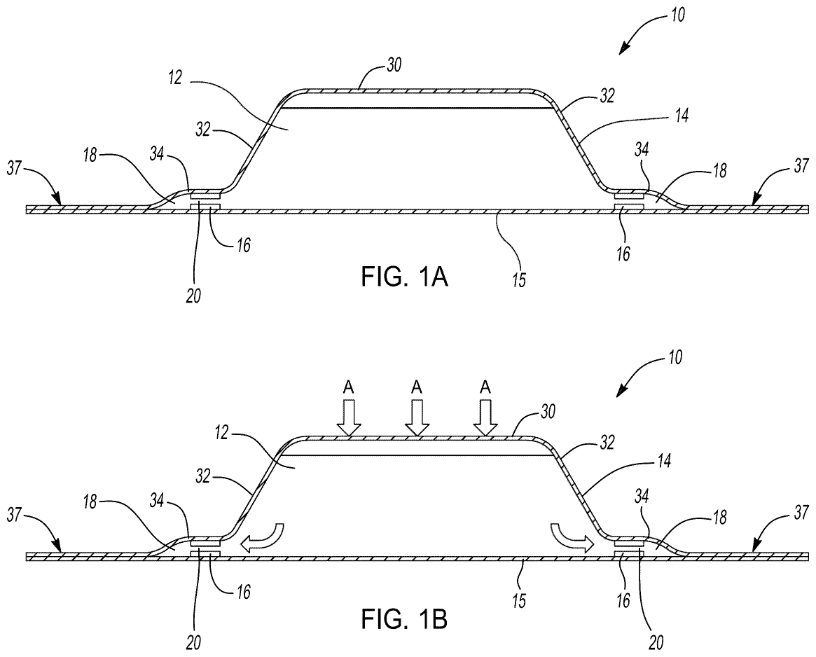

With reference to FIG. 1, a hydraulic shock absorbing device 10 is shown (also referred to as “the shock absorbing device 10”). The shock absorbing device 10 includes a first contiguous membrane 14 and a second contiguous membrane 15 that cooperate to define a primary liquid reservoir 12. The first contiguous membrane 14 and the second contiguous membrane 15 (collectively, “the membranes”), may be a polymeric material. The membranes 14, 15 may be impermeable. The membranes 14, 15 may include a waterproof fabric. Any other suitable material having a high tensile strength may be utilized. In some example embodiments, the first contiguous membrane 14 may be bonded to an orifice ring 16. The orifice ring 16 may be a polymeric material. The orifice ring 16 may be a dense polymeric material. The first contiguous membrane 14 may include a first or top wall 30, a second or side wall 32, and a third or base wall 34 that extends radially outward from side wall 32. The base wall 34 of the first contiguous membrane 14 is connected to the second contiguous membrane 15 at perimeter portion 37. A secondary liquid reservoir 18 is defined between the base wall 34 and the second contiguous membrane 15. The primary liquid reservoir 12 is fluidly connected to the secondary liquid reservoir 18 through at least one orifice 20. In some example embodiments, one or more of the orifices 20 may be disposed within the orifice ring 16 to fluidly connect the primary liquid reservoir 12 and the secondary liquid reservoir 18.

The first contiguous membrane 14 is configured to move between a first or uncompressed state (FIGS. 1A-1B) and a second or compressed state (FIG. 1C). When the shock absorbing device 10 is in the first position, fluid is disposed within the primary liquid reservoir 12. When an impact (e.g., impact along axial direction A) is applied to the shock absorbing device 10, the impact energy transfers to the first contiguous membrane 14. It is contemplated that the impact may be at an angle (e.g., causing shear force). Upon the impact, the first contiguous membrane 14 is configured to collapse into the second position (FIG. 1C). A volume of the primary liquid reservoir 12 decreases and the internal fluid pressure increases causes liquid disposed in primary liquid reservoir 12 to move to the secondary liquid reservoir 18 via the orifices 20. The first contiguous membrane 14 and the orifice ring 16 may expand near the base wall 34 with the increased pressure from the fluid.

The liquid used in the liquid reservoirs 12, 18, as described herein, may be water, but may also include other fluids that enable the primary liquid reservoir 12 and, therefore, the shock absorbing device 10 as described herein to better absorb energy impacted thereto. Such fluids may include glycol, glycerin, gels, or other like fluids.

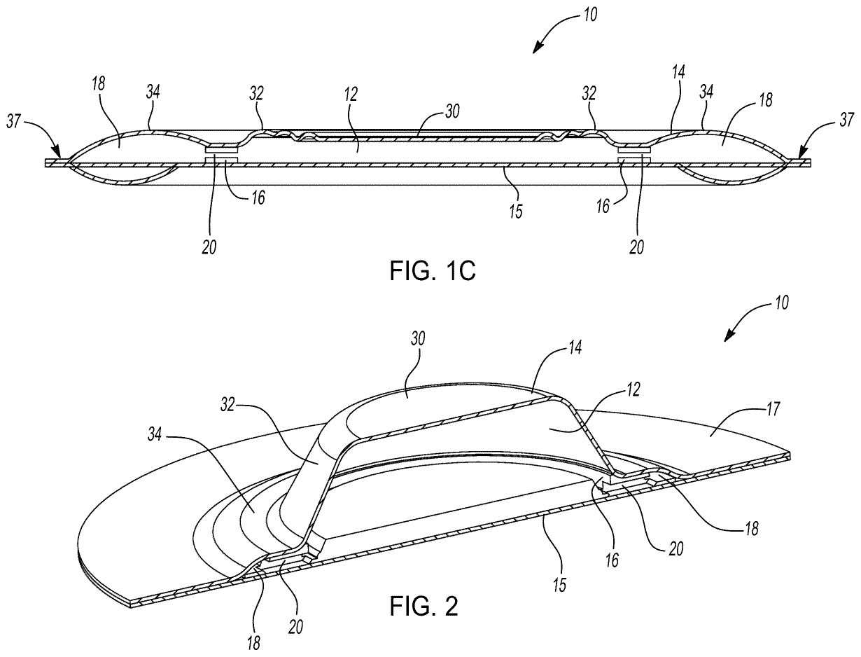

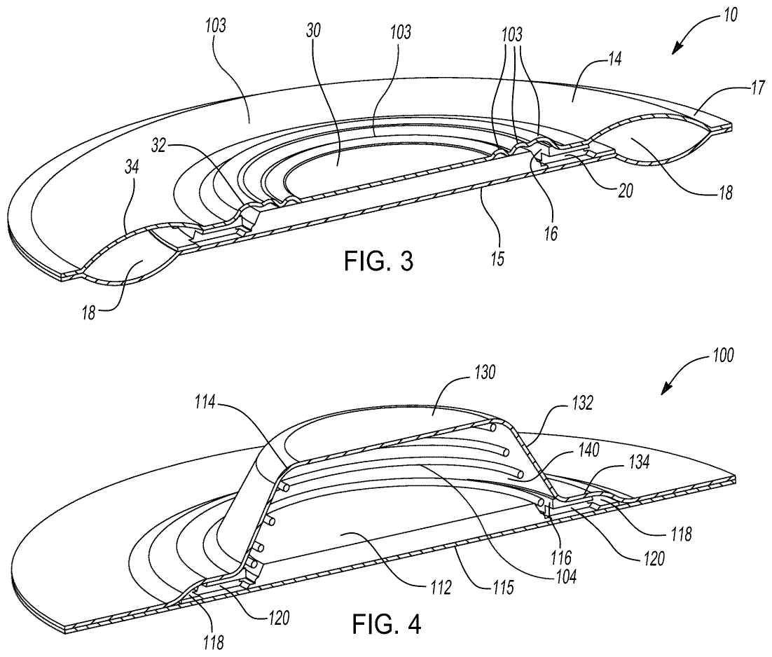

The energy required to accelerate the liquid through the orifices 20 effectively decelerates or dissipates impact energy and reduces the observed forces on the underlying support. In turn, as shown in FIGS. 2 and 3, the shock absorbing device 10 and specifically the primary liquid reservoir 12 goes from a first expanded or uncompressed position (FIG. 2) to a second compressed position (FIG. 3) during impact. In the first position, the first contiguous membrane 14 may be relatively flat (e.g., free of or having minimized surface features). In the second compressed position, the compression of the first contiguous membrane 14 may form a plurality of ridges, wrinkles, folds, or other similar features 103 in the material (FIG. 3). These ridges, wrinkles, folds, or other similar features 103 may also dissipate the impact force on the shock absorbing device 10, such as, especially when subject to, shearing forces or glancing forces that may impact the first contiguous membrane 14.

Shock absorbing devices 10 may be utilized in scenarios of single use impacts. Alternatively, the shock absorbing devices 10 may be reusable. When the shock absorbing device is reusable, the first contiguous membrane 14 may return to its original shape upon release of the impact pressure. Additionally or alternatively, applying pressure to the first contiguous membrane 14 and/or the orifice ring 16 near the secondary liquid reservoirs 18 force the liquid back through the orifices 20 into the primary liquid reservoir to refill the primary liquid reservoir 12 to a state of readiness after the impact for subsequent impact events. In a single-use impact device, the liquid may burst from the primary liquid reservoir 12 and/or secondary liquid reservoir 18 and does not return. When this happens, there may also be an indicator, such as a color added to the liquid to indicate that the device 10 has indeed been ruptured. Other indicators may include windows that show color changes when the primary reservoir 12 bursts, or visual changes in the first contiguous membrane 14 and/or the orifice ring 16.

In some example embodiments, the membranes 14, 15 are flexible and waterproof with very high tensile strength and adequate stiffness. Shock absorbing devices constructed from high tension fabrics may not require incorporation of an orifice ring (i.e., are free of orifice ring 16). In one embodiment, the membranes 14, 15 include thermoformed Polyurethane coated Nylon fabric such as 420 Denier heat-weldable waterproof packcloth. Other membrane materials include a range of waterproof cloth laminates and may be composite materials that incorporate two or more layers of material that include, polyester, vinyl, silicone, Miylar®, Dyneema® or similar, fiberglass, carbon fiber, aramid fiber, hemp fiber or others. Molded, insert-molded or formed plastic or rubber films can also be used. In the present disclosure, the use of the term “membrane” to describe the material that the shock absorbing devices are constructed from is meant to refer to any material (film, fabric, nonwoven, etc.) that may be suitable to reversibly compress under an impact. Moreover, the shock absorbing device 10 may have a substantially flat first wall 30 and base wall 34 that are connected by side wall 32 having steep hyperbolic cross-sectional curvature. In other example embodiments, the shock absorbing device 10 may have a cross-section that is or mounded, although other shapes are contemplated.

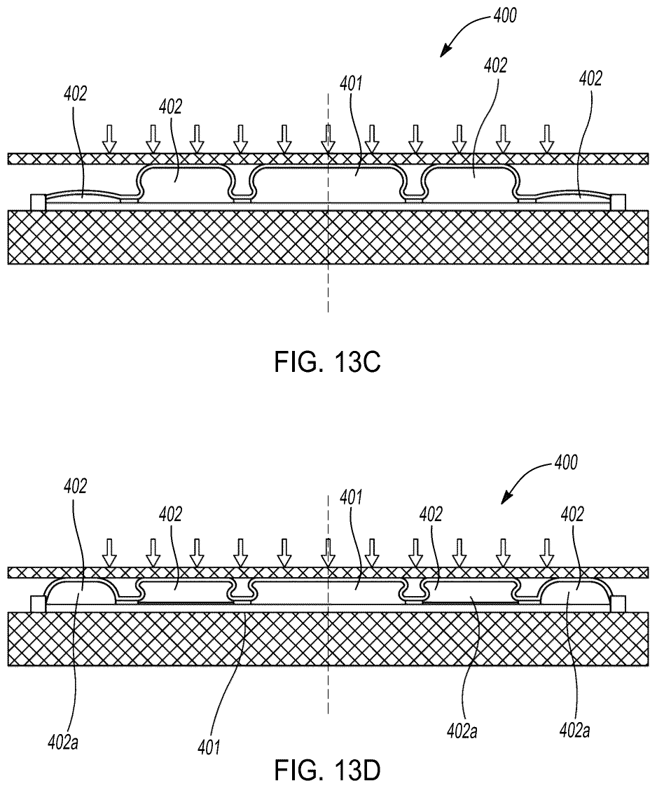

With reference to FIG. 10, a shock absorbing device 380 is shown. The shock absorbing device 380 includes a first contiguous membrane 384 and an orifice ring 386. The first contiguous membrane 384 may be fixed to the orifice ring 386. The orifice ring 386 includes at least one or more orifices 390 spaced radially around its perimeter and directed roughly orthogonal to a radial axis A of the first contiguous membrane 384. Orifices 390 fluidly connect a primary liquid reservoir 392 defined by first contiguous membrane 284 to a secondary liquid reservoir (not shown). The orifice ring 286 may be injection-molded, cast or 3D-printed elastomeric material such as TPU, TPE, silicone or natural rubbers or it may be fabricated from a rigid plastic or metal material. Orifice size, number and shape can be varied, in conjunction with the volume/stroke of the first contiguous membrane 284 as well as the dynamic viscosity of the hydraulic fluid, in order to tune the specific impact performance of the shock absorbing device 380. For example, a higher viscosity liquid will require more total orifice area compared with a low viscosity fluid, in order to achieve similar force response curves. Careful design of the orifice area and provision for a secondary liquid reservoir allows for a nearly constant reaction force response across nearly the entirety of the physically available stroke for the range of impact energies encountered.

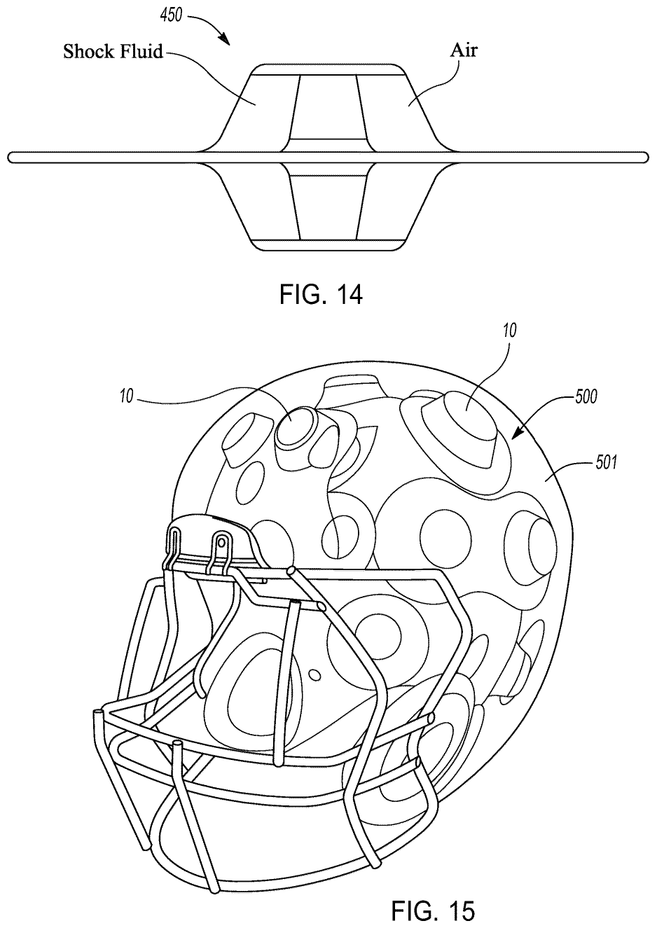

The secondary liquid reservoir is fluidly connected to the primary liquid reservoir 392 via at least one orifice 390. Optionally, primary liquid reservoir 392 is remotely connected via tubes running from each orifice 390 to one or more secondary liquid reservoirs. In one embodiment, as best shown in FIG. 11, the primary liquid reservoir 312 may be disposed radially around orifice ring 316 and is defined by the first contiguous membrane 314 and a second contiguous membrane 315. The first contiguous membrane 314 and the second contiguous membrane 315 may be connected or bonded at a perimeter area 317. As the first contiguous membrane 314 and/or the second contiguous membrane 315 are compressed, the volume of primary liquid reservoir 312 is compressed and liquid is forced through orifices 320 to the secondary liquid reservoir 318. When liquid is forced into the secondary liquid reservoir 318, the first contiguous membrane 314 and the second contiguous membrane 315 may be spaced apart near the perimeter area 317.

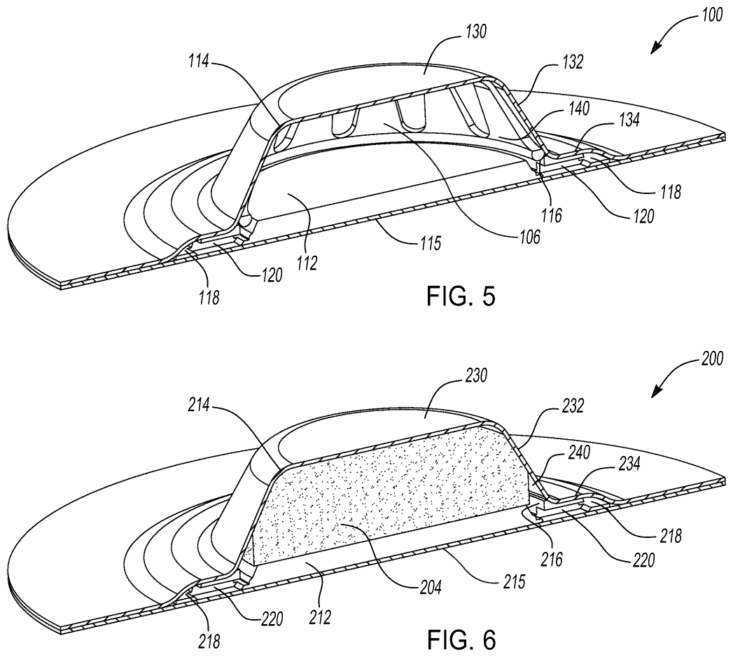

With renewed reference to FIGS. 1A-1C, the second contiguous membrane 15 may be formed through regional bonding of the same contiguous sheet of membrane material that was formed to create the first contiguous membrane 14. Use of membrane material reduces the total number of parts required in construction of the device, and also reduces the potential for leaking, should a failure occur in the adhesive bond with the orifice ring 16. However, the second contiguous membrane 15 may be fabricated in a number of ways that include separate inextensible but flexible pouches or by using extensible elastic materials that will stretch as liquid escapes from the primary liquid reservoir 12. Regions in the second contiguous membrane 15 may be locally welded to limit the extensibility or expandibility of specific areas. This can allow for tailoring the shape of the secondary liquid reservoir 18. Through holes may be formed within locally welded regions to enable connection between the first contiguous membrane 14 and the second contiguous membrane 15. Foam, plastic, or metal spring elements may be joined to the first contiguous membrane 14 and/or the second contiguous membrane 15 to provide external spring force to enable liquid return to the primary liquid reservoir 12 (see, e.g., spring elements of FIGS. 4-7).

The liquid used in the present shock absorbing device 10 may be any relatively incompressible liquid although low-density, low-viscosity, non-toxic fluids with low freezing points are most desirable. In a preferred embodiment, a high percentage mixture of Propylene Glycol and water is desirable for its low-freezing point and low toxicity but other fluids such as water, mineral oil, isopropyl alcohol, or others may also be used depending on the application. Additionally, mixtures of various liquids or the addition of microspheres may be used to create specific viscosities or lower density solutions to reduce weight.

The liquid contained within the primary liquid reservoir 12 may be at a differential partial pressure to its counterpart (i.e., water vapor) present in the atmosphere surrounding the chamber. To counter liquid mass gain and/or loss due to osmotic vapor transport across partially permeable fabric laminations, a proportion of water will be provided to the liquid mixture sufficient to permeate the membrane across the range of anticipated relative humidities encountered during use, maintaining the acceptable range of nominal volumes of the shock chamber.

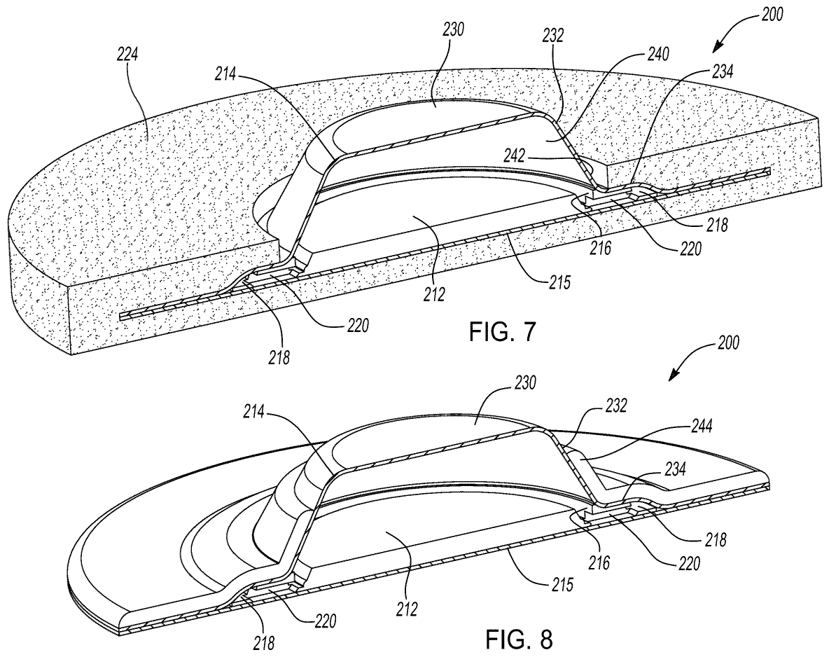

With reference to FIGS. 4 and 5, another shock absorbing device 100 is shown. The shock absorbing device may be the same as or similar to shock absorbing device 10 except as otherwise described below. The shock absorbing device 100 includes a first contiguous membrane 114 and a second contiguous membrane 115. The first contiguous membrane 114 includes a first or top wall 130, a second or side wall 132, and a third or base wall 134. The first contiguous membrane 114 and the second contiguous membrane 115 cooperate to define a primary liquid reservoir 112 and a secondary liquid reservoir 118. The first contiguous membrane 114 is connected to orifice ring 116. During an impact, liquid in the primary liquid reservoir 112 moves to the secondary liquid reservoir 118 via one or more orifices 120.

As best shown in FIG. 4, in one example embodiment, the shock absorbing device 100 includes coil springs disposed on an inner surface 140 of the first contiguous membrane 114. As best shown in FIG. 5, in another example embodiment, the shock absorbing device may include spring fingers 106 disposed on the inner surface 140 of the first contiguous membrane 114. The springs 104, 106 enable the first contiguous membrane 114 to return to the first uncormpressed state after an impact by decreasing an internal pressure of the primary liquid reservoir 112. The springs 104 may be constructed from foam, spring fingers, or air bladders. The springs 104 may be a polymeric material or any other suitable material. The spring fingers 106 may a polymeric material or any other suitable material. Optionally, the springs 104 and/or the spring fingers 106 may be laminated to the first contiguous membrane 112 enable the first contiguous membrane 112 to spring it back to its original shape.

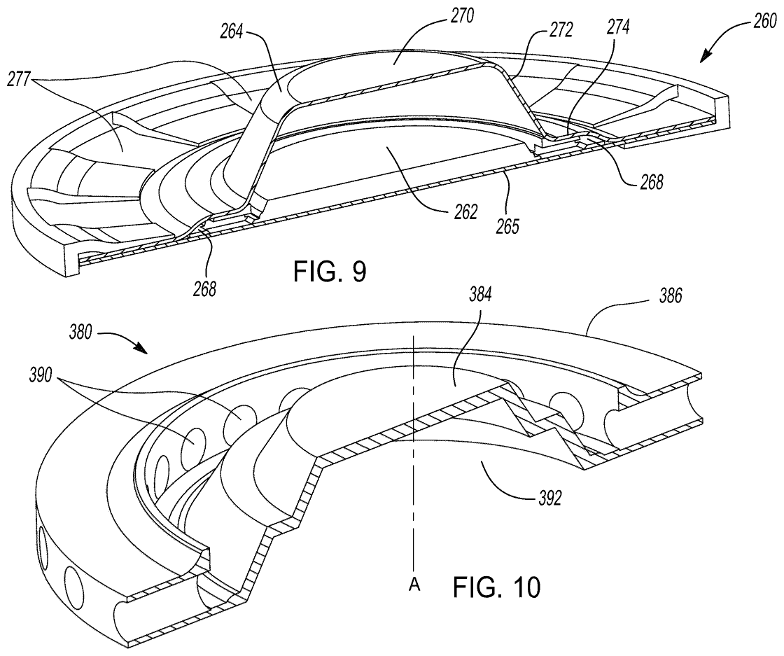

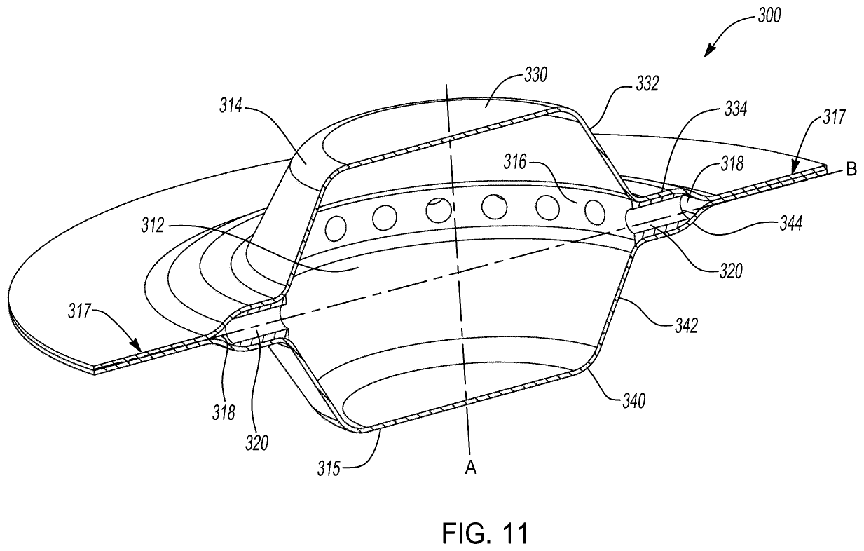

With reference to FIGS. 6 and 7, another shock absorbing device 200 is shown. The shock absorbing device may be the same as or similar to shock absorbing device 10 and/or 100 except as otherwise described below. The shock absorbing device 200 includes a first contiguous membrane 214 and a second contiguous membrane 215. The first contiguous membrane 214 includes a first or top wall 230, a second or side wall 232, and a third or base wall 234. The first contiguous membrane 214 and the second contiguous membrane 215 cooperate to define a primary liquid reservoir 212 and a secondary liquid reservoir 218. The first contiguous membrane 214 is connected to orifice ring 216. During an impact, liquid in the primary liquid reservoir 212 moves to the secondary liquid reservoir 218 via one or more orifices 220.

As shown in FIG. 6, a pad 204 may be disposed in the primary liquid reservoir 212 between the first contiguous membrane 214 and the orifice ring 216. The pad 204 may contact an inner surface 140 of the first contiguous membrane 214. The pad 204 may include foam. The pad 204 may include a low-density open-celled elastic foam (e.g., reticulated Polyurethane foam). The pad 204 may be configured to absorb at least a portion of an impact force. The pad 204 may be reversibly compressible. When impact load is removed from the first contiguous membrane 214, the pad 204 will return to its uncompressed state and force the first contiguous membrane 214 into its first uncompressed shape thereby lowering the pressure in the primary liquid reservoir 212 and sucking the liquid back from secondary liquid reservoir 218.

As shown in FIG. 7, a pad 224 may be disposed outside of the primary liquid reservoir 212. The pad 224 may be the same as or similar to pad 204 except as otherwise described. The pad 224 may contact an outer surface 242 of the first contiguous membrane 214 and/or the second contiguous membrane 215.

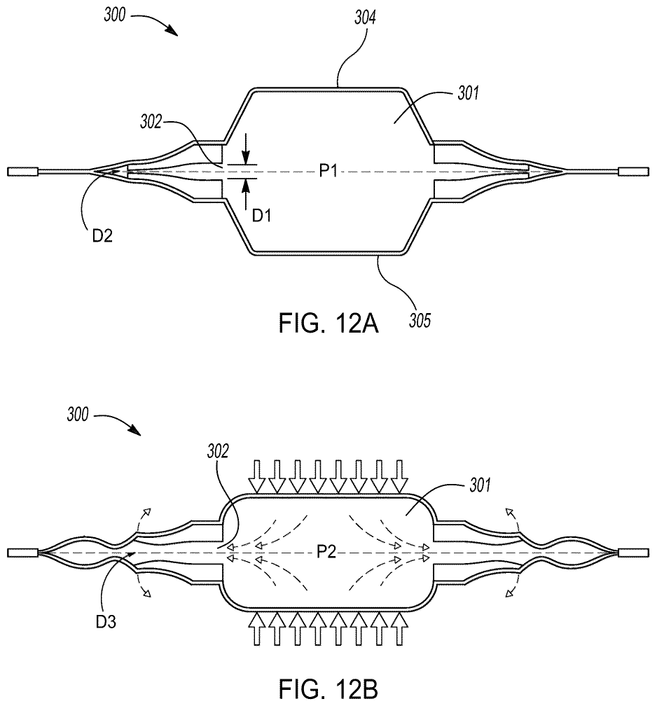

With reference to FIG. 8, another pad 244 is shown. Pad 244 may be the same as or similar to pad 224 except that pad 244 may include medium to high density foam. The pad 244 may include rubber. The pad 244 may be externally laminated to the first contiguous membrane 214 and/or the second contiguous membrane 215 to create spring-like liquid return pressure according to the present disclosure.

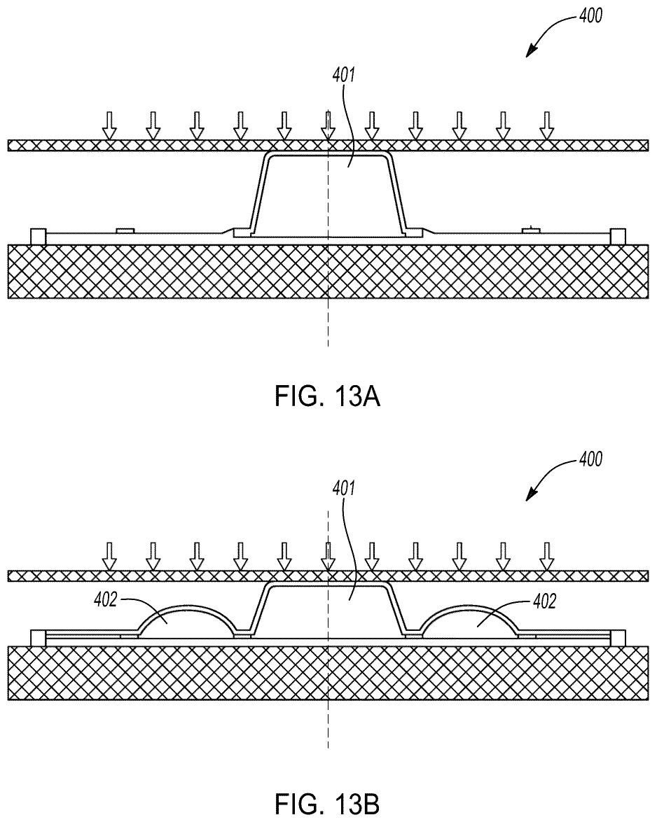

With reference to FIG. 9, another shock absorbing device 260 is shown. The shock absorbing device 260 may be the same as or similar to shock absorbing device 10, 100, and/or 200 except as otherwise described below. The shock absorbing device 260 includes a first contiguous membrane 264 and a second contiguous membrane 265. The first contiguous membrane 264 includes a first or top wall 270, a second or side wall 272, and a third or base wall 274. The first contiguous membrane 264 and the second contiguous membrane 265 cooperate to define a primary liquid reservoir 262 and a secondary liquid reservoir 268. The first contiguous membrane 264 includes one or more orifice channels 277. During an impact, liquid in the primary liquid reservoir 262 moves to the secondary liquid reservoir 268 via one or more orifice channels 277.

The orifice channels 277 may be fabricated by selectively welding of the first contiguous membrane 264 and the second contiguous membrane 265. In this embodiment, the unwelded regions of the primary reservoir and collection reservoir are connected by radial unwelded channels 277. In the example embodiment of FIG. 9, the orifice channels are configured like the spokes of a wagon wheel. This configuration allows for minimal total parts and maximum shock stroke (i.e., compression of the first contiguous membrane and/or the second contiguous membrane).

In yet another embodiment of the shock absorbing device individual reservoirs may be joined via common collection reservoirs. Two or more primary liquid reservoirs, each with its own orifice ring, may be mutually attached to a common secondary liquid reservoir. Such an arrangement may enable desirable geometries and shock spacing, reduce total part count and provide assembly efficiency.

With reference to FIG. 11, another shock absorbing device 300 is shown. The shock absorbing device may be the same as or similar to shock absorbing device 10, 100, 200, and/or 260 except as otherwise described below. The shock absorbing device 300 includes a first contiguous membrane 314 and a second contiguous membrane 315. The first contiguous membrane 314 includes a first or top wall 330, a second or side wall 332, and a third or base wall 334. The second contiguous membrane 315 includes a first or top wall 340, a second or side wall 342, and a third or base wall 344. The shapes of the first contiguous membrane 314 and the second contiguous membrane 315 may be the same except that the second contiguous membrane is oriented opposite the first contiguous membrane 314. The first contiguous membrane 314 defines and the second contiguous membrane 315 cooperate to define a primary liquid reservoir 312 and a secondary liquid reservoir 318 therebetween. The first contiguous membrane 314 and second contiguous membrane 315 are connected to orifice ring 316. During an impact, liquid in the primary liquid reservoir 212 moves to the secondary liquid reservoir 218 via one or more orifices 320. The primary liquid reservoir 312 may be symmetric about a first axis A and a second axis B. This configuration allows for twice the available shock stroke and may be desirable for many applications.

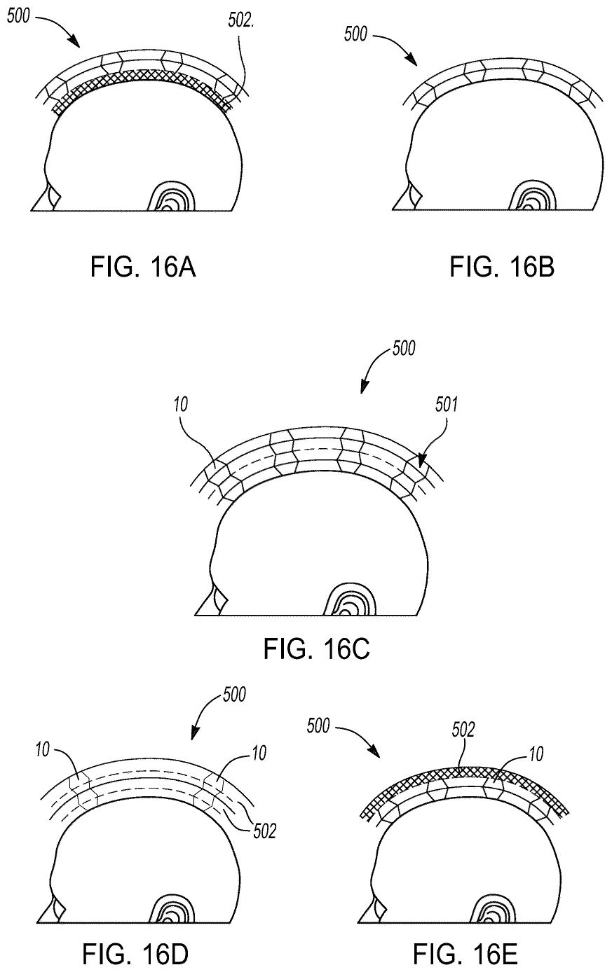

FIGS. 12A-12B show shock absorbing device 300 utilizing pressure-activated, progressively adaptive orifices 302 according to the present disclosure. Flexible polymer material and tapered geometries in the orifice 302 enables the orifice volume to increase as pressure increases. For example, in FIG. 12A, the initial diameters D1 and D2 of the orifice 302 sequentially increases to D3 (FIG. 12B) as the impact pressures increases (P1 to P2) forcing the fluid from the primary liquid reservoir 301 out through the orifice 302 (FIG. 12B). In this way, orifice 302 can adapt for higher flow rates during higher energy impacts on both the top 304 and bottom 305 of the primary liquid reservoir 301.

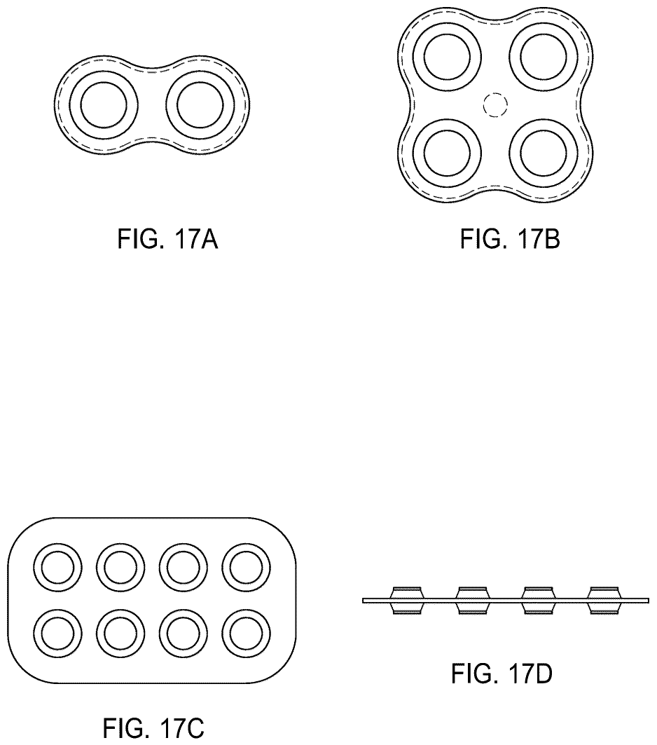

FIG. 13 illustrates another embodiment of the shock absorbing device 400 wherein the secondary liquid reservoir 402 can be fabricated such that a series of sequentially engaged secondary liquid reservoir chambers 402 are filled by the liquid leaving the primary reservoir 401. As each collection reservoir 402 is filled, it inflates to a height greater than the fully compressed height of the shock absorbing device 400 (B and C). As an impact compresses the shock absorbing device 400 further, each collection reservoir 402 fills until all collection reservoirs are filled and are of equal compressed height (D). In this way, the same liquid volume can be used to dissipate impact energy multiple times during a single impact event.

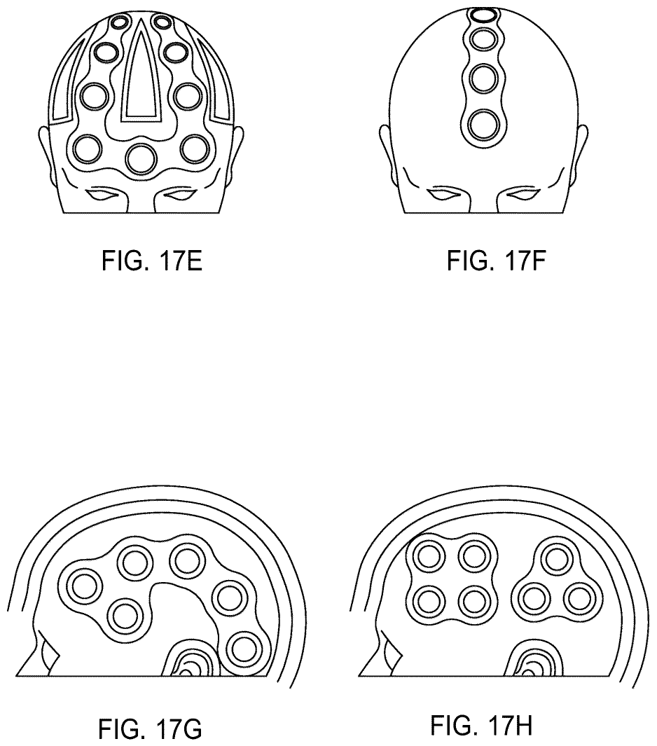

FIG. 14 illustrates an embodiment for reduced system mass applications for the shock absorbing devices of the present disclosure. An example shock absorbing device 450 is shown. Minimization of system mass is anticipated to be of critical importance to several use cases. Coaxial shock chambers provide a central volume of liquid surrounded and supported by an annular volume of foam, air, and/or other gases. Since the volume of a cylinder or truncated cone is proportional to the square of the radius, reduction of cross-sectional diameter by a factor of two results in a reduction of liquid volume (and therefore liquid mass) by a factor of 4. As shock chamber cross-sectional area decreases, maintaining equivalent reaction force response may require significantly higher system pressures, which may require the use of ultra-high strength and stiffness fabric laminates, such as fiber reinforced elastomer composites, employing high performance fiber fabrics such as carbon fiber, fiberglass, aramid, spectra, and Dyneema®. Additionally, convolutions in the waterproof fabric structure geometry reduce the in-plane stresses for a given pressure. Creating a “bellows-like” convoluted configuration may alleviate the requirement for use of the highest strength fibers.

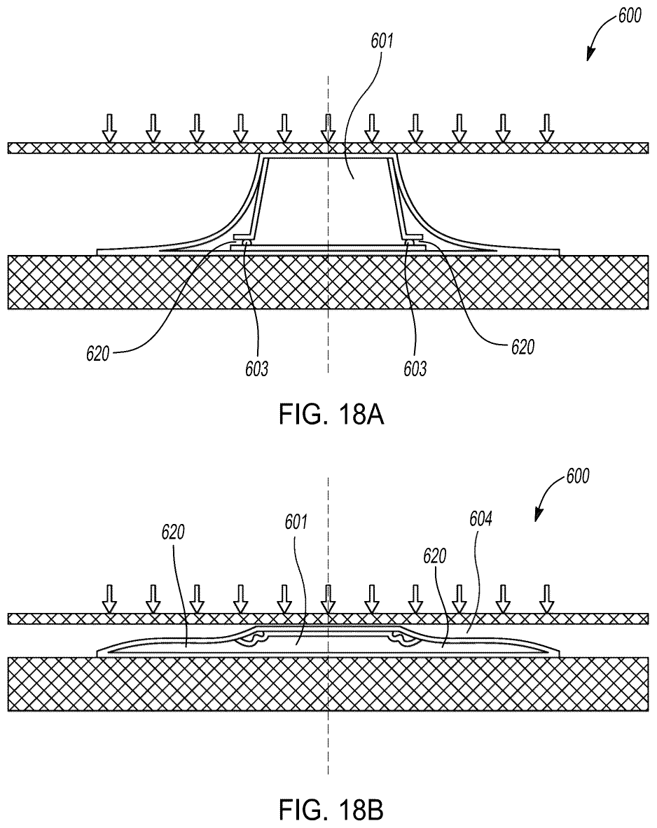

With reference to FIG. 15, a device 500 includes one or more shock absorbing devices 10. The device 500 may be sporting equipment. The device 500 may be personal protection equipment. As shown in FIG. 15, the device 500 is a football helmet. Any one of the embodiments of shock absorbing devices described here may be used on the helmet. One or more shock absorbing devices 10 may be combined to share secondary collection reservoirs, as appropriate, to effectively cover a protection zone.

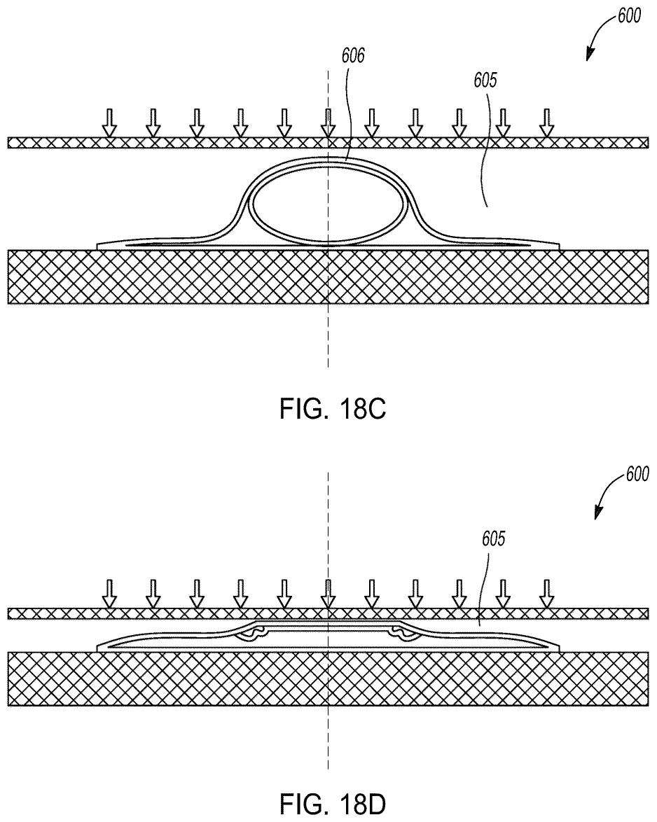

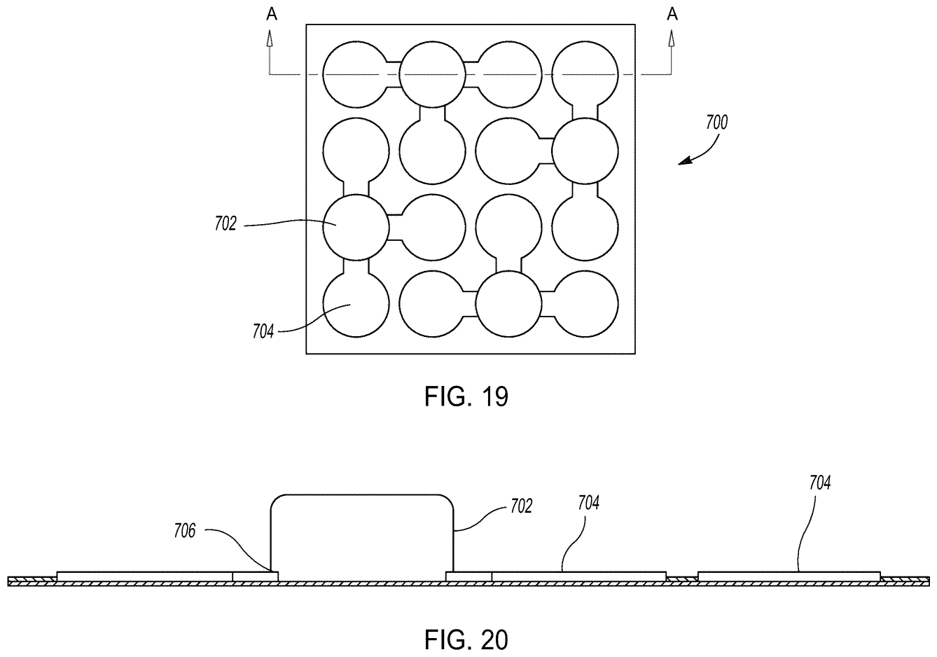

FIG. 16 illustrates an array of shock absorbing devices 10 employed to absorb shock in a helmet construction according to the present disclosure. Shock absorbing devices 10 may be positioned between a rigid outer helmet shell 501 and other rigid layers of protective foam 502 (See, 16A, 16D, 16E) or be utilized as an inner comfort/cushion layer (B). Shock absorbing devices may be configured to operate as independent fluidic systems or as fluidically communicating networks, sharing flow circuits and common reservoirs. Configurations of one, two, three, or four, or more individual shock absorbing devices may be interconnected to provide customized coverage areas and tailored impact attenuation response (C). Also contemplated are large numbers of small liquid chamber “cells” in fluidic communication and/or standalone configuration, such as those illustrated in FIGS. 17A-17H. Similar to air filled “bubble wrap” sheet products, this embodiment may comprise a large number (i.e., 20, 50, 100 or more) of relatively small (i.e., less than or equal to about 15 mm diameter and/or less than or equal to about 15 mm axial height) liquid capsules arranged on a flat pattern plane, articulated to be conformable to a curved surface similar to that of a human head or other body part.

In another embodiment of the present invention, an array of multiple shock absorbing devices may share a common collection reservoir and how these may be utilized to cover various regions on a human head. For example, the present invention may include a plurality of primary liquid reservoir chambers, each of which may be connected in fluid relationship with a single liquid reservoir chamber such that each of the plurality of primary fluid reservoir chambers may selectively or together, depending on the force applied thereto, cause fluid to flow from the primary fluid reservoir chambers into the single liquid reservoir.

It should be understood that the arrangement of shock absorbing devices provided in the present disclosure may also be used to provide comfort and proper fit in a wearable article or item. For example, any particular arrangement of the shock absorbing devices provided in the present disclosure may be useful for wearable items, such as a helmet, such that the helmet can be worn by a variety of head shapes. The fluid-filled nature of the present devices enable the devices to change and adjust as needed to ensure the wearer has a firm and comfortable fit to the item, regardless of head shape. For example, fluid may flow between reservoirs to adjust the form of the reservoirs to better fit a user. Also, membranes utilized to form the shock absorbing devices described herein may stretch to better fit a user. Of course, any other mechanism may be utilized to form a better fit for a user when utilized.

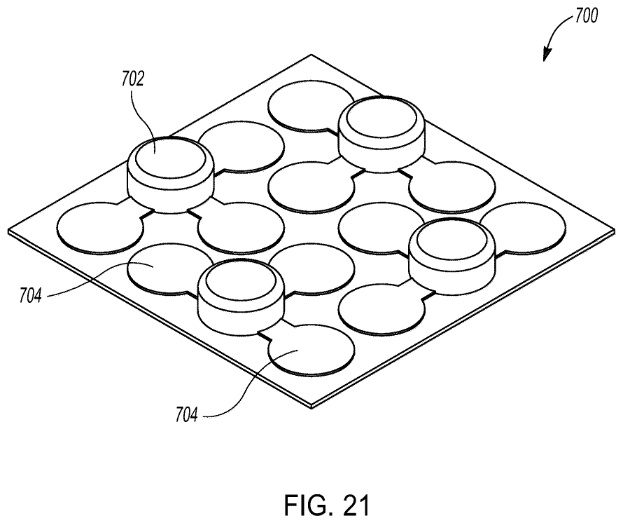

FIG. 18 illustrates an embodiment of a shock absorbing device 600 in which the liquid in the primary liquid reservoir chamber 601 statically contained by one or more seals 603 obstructing one or more orifice ports 620 (FIG. 18A). At a predetermined design pressure threshold, the orifice seals 603 may burst, allowing rapidly accelerated liquid flow to occur and absorbing impact energy (FIG. 18B). These burst seals 603 may also be joined seams designed to separate at predetermined pressure levels. The shock liquid, once jettisoned from the primary liquid reservoir chamber 601, may be caught and contained by a surrounding, impermeable liquid capture bag 604 (FIG. 18B). This bag 604 can be made of thin, flexible plastic film of sufficient size and strength to contain high velocity jets of shock liquid and may be transparent or translucent to allow visual indication of the change of state of the burst seals. Shock liquid may be dyed a vibrant color to facilitate visual communication of the change of state of the shock absorber.

Alternatively, in another example embodiment shown in FIG. 18C, the primary chamber may be provided in the form of a “gel-cap,” including a capsule 606 made of polymer material statically containing shock liquid and designed to rupture at a predetermined pressure (FIG. 18C). Upon the capsule's 604 rupture, the shock liquid is jettisoned at high velocity into a surrounding liquid capture bag 605, where it provides visual indication of change of state of the shock chamber (FIG. 18D).

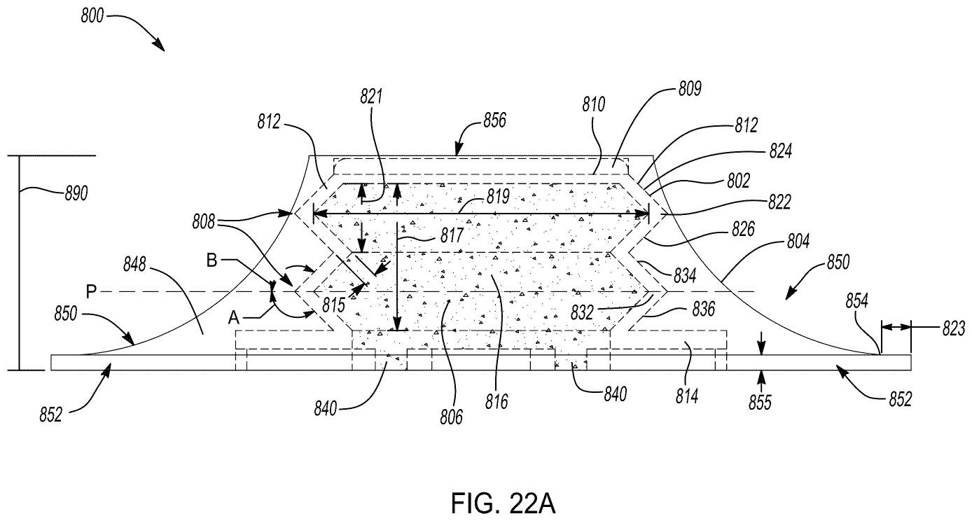

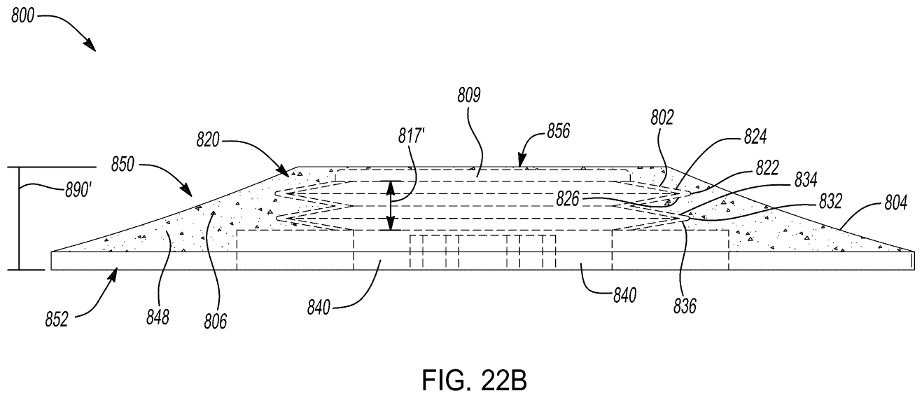

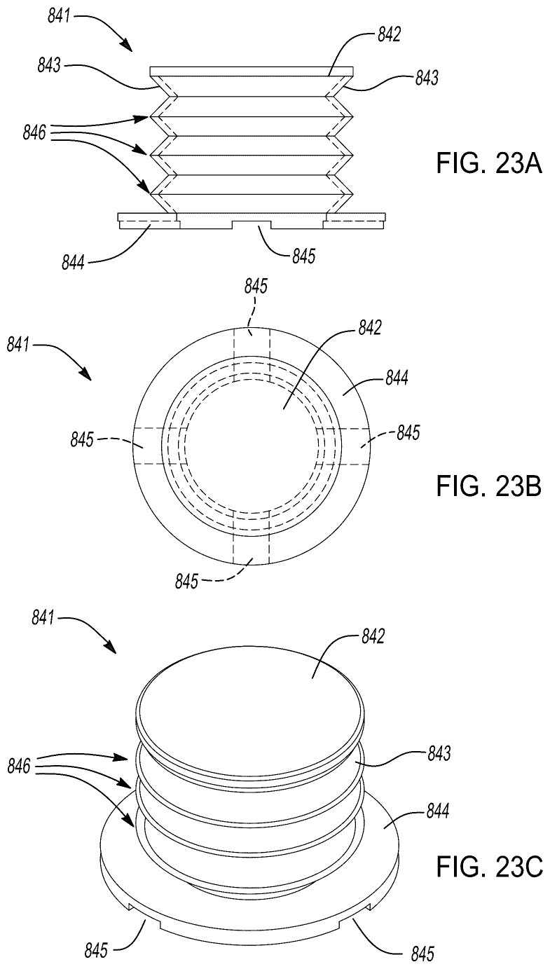

FIGS. 19-21 illustrate an exemplary embodiment of an assembly of shock absorbing devices 700. The assembly 700 includes a series of interconnected primary liquid reservoirs 702 and secondary liquid reservoirs 704. The primary liquid reservoirs 702 may be fluidly connected to the secondary liquid reservoirs 704 through orifices 706, as previously described. The present assembly of shock absorbing devices 700 are useful for positioning in multiple areas of any article needing impact protection and/or comfort and fit adjustability. The assembly of shock absorbing devices 700 may be formed from a pair of heat sealable membranes that may be heat sealed together, with fluid filled primary liquid reservoirs 702, secondary liquid reservoirs 704 and orifices 706 between the primary liquid reservoirs 702 and the liquid reservoirs 704. Although the orifices may form open passages, fabric or membrane tension on the orifices may hold the fluid in the primary liquid reservoirs 702 until a sufficient force is applied to the primary liquid reservoirs 702, at which time the fluid may force open the orifices 706 to allow fluid to flow therethrough into the liquid reservoirs 704. In a preferred embodiment, once the force is removed, the fluid may flow back through the orifices from the liquid reservoirs 704 back into the primary liquid reservoirs 702 for multiuse applications.

The present shock absorbing devices may also be provided as a single-use embodiment, where no return system is required for the fluid. Engineered seals or check valves may rupture or open when a predetermined pressure threshold has been reached. Liquid may be allowed to simply escape or it may be collected by housing all or part of the shock absorbing device inside a thin waterproof membrane such as a low-density polyethylene or silicone bag. Such a configuration could also use colored liquid to indicate to the user that a shock rupture has occurred. The orifices 706 may be selectively expandable or constrictive based on a number of factors, including the material that may be used, the force applied to the primary liquid reservoirs 702, the location of the forces applied to the primary liquid reservoirs, the vectors of the forces applied to the primary liquid reservoirs, and/or other factors. Thus, the rate of fluid flow between the primary liquid reservoirs 702 and the liquid reservoirs 704 may be controlled for different applications.

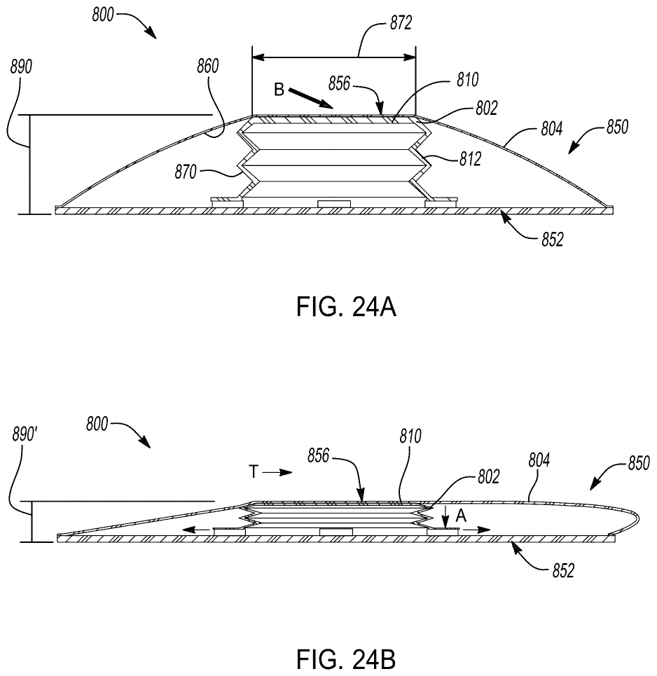

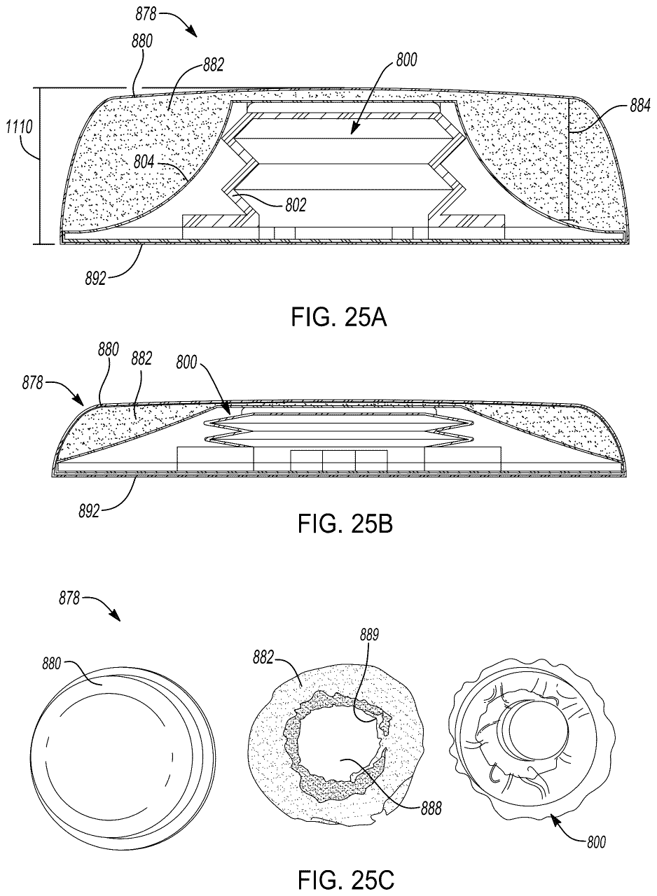

With reference to FIGS. 22A-22B and 23A-B, a shock absorbing device 800 includes a first contiguous membrane or bladder 802, a second contiguous membrane or reservoir 804, and internal fluid 806. The bladder 802, reservoir 804, and internal fluid 806 may cooperate to attenuate the force of an impact to the shock absorbing device 800. The bladder 802 may include a first or top wall 810, a second or side wall 812, and a third or base wall 814 that cooperate to define a primary collection reservoir 816 therebetween. In a first or uncompressed position, the internal fluid 806 is disposed within the primary liquid reservoir 816.

The first wall 810, side wall 812, and base wall 814 may be integrally formed (e.g., from a single piece of material). It is contemplated that the first wall 810, side wall 812, and base wall 814 may alternately be formed from distinct pieces that are joined together (e.g., by molding, bonding, stitching, fastening, gluing, etc.). The bladder 802 may be formed by 3D printing, injection molding, or any suitable process. The bladder 802 may include a polymeric material The bladder 802 may include a thermoplastic polymeric material. In some embodiments, the bladder 802 includes polyurethane. In some embodiments, the bladder 802 may include silicone. It is contemplated that any material suitable for 3D printing and/or injection molding processes may be utilized to fabricate the bladder 802. The side wall 812 has a thickness 815 that is greater than or equal to about 0.1 mm to less than or equal to about 8.0 mm. The side wall 812 may define a dimension or height 817 that is greater than or equal to about 4.0 mm to less than or equal to about 75 mm in a first or uncompressed positions (FIG. 22A).

The first wall 810 may have a generally circular shape (see, e.g., top wall 842 of FIGS. 23A-23C). However, it is contemplated that the shape of the bladder 802 may be tuned such that the first wall 810 may have a triangular, square, rectangular, hexagonal, octagonal, or any other shape.

The shock absorbing device 800 may further include a plate 809 disposed adjacent the top wall 810 of the bladder 802. In some example embodiments, the plate 809 may be the same material as the bladder 802. In some other example embodiments, the plate 809 may be a different material. When the plate 809 is a different material, it may have a higher stiffness than the material of the bladder 802. The plate 809 is configured to restrict circumferential expansion of the bladder 802. Additionally or alternately, the plate 809 is configured to absorb at least a portion of the impact energy from an impact. The plate may be configured to break or shatter upon impact, thereby reducing the amount of impact energy directed towards bladder 802.

The bladder 802 may be configured to function as a spring within the shock absorbing device and move between a collapsed state upon impact and an undeformed state after impact. The bladder 802 may include one or more collapsible features 820. As shown in the example embodiment of FIGS. 22A-22B, the collapsible features 820 are bellows (also referred to as the “bellows 820”). Each of the bellows may have a maximum dimension 819 or diameter in a first or uncompressed state. A dimension 821 or height of each of the bellows 820 may be about 5% to about 50% of the dimension 819. The dimension 821 may be greater than or equal to about 0.5 mm to less than or equal to about 15.0 mm.

The bladder 802 may include a first bellow 822 that includes a first surface 824 and an opposing second surface 826. The bladder 802 may include a second bellow 832 that includes a first surface 834 and a second surface 836. Each of the second surfaces 826, 836 may extend at an angle A relative to a plane P of the respective bellow 822, 832. Each of the first surfaces 824, 834 may extend at an angle B relative to the plane P of the respective bellow 822, 832. Each of the angles A, B may be greater than or equal to about 100 degrees to less than or equal to about 160 degrees. As best shown in FIG. 22A, in a first position the second surface 826 of the first bellow 822 and the first surface 834 of the second bellow 832 are spaced apart. When the bladder 802 is in a second or collapsed position, as best shown in FIG. 22B, the second surface 826 of the first bellow 822 and the first surface 834 of the second bellow 832 are compressed. In the second position, the second surface 826 of the first bellow 822 and the first surface 834 of the second bellow 832 may be slightly spaced apart, or the second surface 826 of the first bellow 822 may contact the first surface 834 of the second bellow 832.

The thickness 815 of the side wall 812, the height 817 of the side wall 812, the bellow angles A and B, and the bellow height 821 may be tailored to achieve the desired shock absorbing characteristics and may be tuned based on expected impact load. Tuning these features will influence initial compression force and spring or restoring force of the shock absorbing device 800. It is contemplated that the thickness 815 of the side wall 812, the bellow angles A and B, and the bellow height 821, may individually be tuned within any shock absorbing device such that each bellow 820 has different impact absorption and spring features. For example, the thickness 815 of the side wall 812 may be larger near the base wall 814 of the bladder 802 than near the first wall 810 of the bladder 802 to enable a tiered impact response. Because a large force may be required to collapse or compress thicker sections of the side wall 812, only the first bellow may collapse in response to a first impact force that is less than a threshold impact force required to collapse the second, thicker, bellow.

The bladder 802 defines one or more orifices 840 extending therethrough. Internal fluid 806 may be configured to flow through orifices 840 during compression of bladder 802 and collapse of the side wall 812. While in the embodiment of FIGS. 22A-22B, the orifices are disposed in the base wall 814 of the bladder 802, it is contemplated that the orifices 840 may be positioned in the side wall 812 and/or first wall 810. The positioning of the orifices may be tailored based on the type and location of impact applied to the shock absorbing device 800. The orifices 840 may have a dimension or diameter that is greater than or equal to about 0.1 mm² to less than or equal to about 100 mm². While four (4) orifices 840 are shown in the embodiment of FIGS. 22A-22B and 23A-23C, any number of orifices 840 may be utilized. The size, shape, and dimension of the orifices 840 may be tailored to achieve desired shock absorbing characteristics of the shock absorbing device 800. For example, more or less orifices may be utilized depending on the expected impact energy that the shock absorbing device is expected to absorb. Additionally, the shape of the orifices 840 may be tuned. It is contemplated that the orifices 840 may be circular, rectangular, square, elliptical, or any other possible shape.

In some embodiments, all or a portion of the bladder 802 may be a porous or mesh material (e.g., a fibrous mesh material comprising fibers and spaces therebetween). When the bladder 802 is a porous or mesh material, the one or more orifices 840 may be defined by the pores and/or space between its fibers. In this way, it is contemplated that the bladder 802 may include tens, hundreds, or even thousands of orifices 840. In other embodiments, it is contemplated that the bladder 802 is an impermeable or non-porous material. Additionally or alternately, the bladder 802 may be coated with an impermeable layer. When the bladder is impermeable or non-porous, the internal fluid 806 may be forced through only the orifices 840 and not through the first wall 810, side wall 812, or base wall 814 of the bladder 802.

Referring to FIGS. 23A-23C, another exemplary bladder 841 is shown. The bladder 841 may be similar to or the same as bladder 802 except as described below. The bladder 841 may include a first or top wall 842, a second or side wall 843, a third or base wall 844, and one or more orifices 845. The side wall 843 may include one or more collapsible features 846. The collapsible features may be bellows (also referred to as the “bellows 846”). In the example embodiment shown in FIGS. 23A-23C, the bladder 841 includes three (3) bellows 846. It is contemplated that any number of bellows 846, the angle of the bellows 846, and the size of the bellows 846 may be tailored to achieve the desired impact absorption and spring characteristics of the bladder 841.

With renewed reference to FIGS. 22A-22B, the reservoir 804 is spaced apart from and may at least partially surround the bladder 802. In the example embodiment of FIGS. 22A-22B, the reservoir is concentric with the bladder 802. The reservoir 804 and the bladder 802 cooperate to define a secondary liquid reservoir 848. The primary liquid reservoir 816 and the secondary liquid reservoir 848 are fluidly connected via the orifices 840.

The reservoir 804 may include a first or top portion 850 and a second or bottom portion 852. The first portion 850 and the second portion 852 may join or connect at a bond area 854. In the example embodiment of FIGS. 22A-22B, the first portion 850 includes a first impact region 856. The first portion 850 is comprised of a single film that flexibly covers the bladder 802. The first portion 850 is configured to reversibly expand or deform upon an impact. The contour or shape of the first portion 850 may correspond to the shape of the bladder 802. In this way, it is contemplated that the top portion 850 has a substantially circular, rectangular, square, triangular, hexagonal, octagonal, shape, or any other shape suitable to absorb impact energy.

The reservoir 804 is impermeable. Therefore, the internal fluid 806 is not permitted to escape from inside the secondary liquid reservoir 848 to an exterior area. Similarly, fluid that is external to the reservoir 804 is not permitted to enter the shock absorbing device 800 (e.g., enter the secondary liquid reservoir 848). The first portion 850 may be formed of an elastic or flexible material. The elastic or flexible material may be configured to expand or deform when the internal pressure of the shock absorbing device 800 increases and returns to its original state when the internal pressure decreases. For example, when internal fluid 806 passes through the orifices 840 from the primary liquid reservoir 816 to the secondary liquid reservoir 848, the pressure in the secondary liquid collection reservoir 848 may increase and the first portion 850 of the reservoir 804 may expand radially outward (see, e.g., FIG. 22B). When the first portion 850 expands radially outward, a first dimension or height 890 of the reservoir 804 is decreased (see, e.g., first or expanded height 890 of FIG. 22A and second or compressed height 890′ of FIG. 22B). The first portion 850 may be a polymeric material. In one example embodiment, the first portion 850 may include a polyurethane film. In some embodiments, the first portion 850 may include a film that is at least partially transparent. When the first portion 850 is at least partially transparent, a user may be able to visually see the internal liquid 806. In other example embodiments, the first portion 850 may include a fabric material.

The bottom portion 852 may be the same as or similar to the top portion 850 except as otherwise described below. In some example embodiments, the bottom portion 852 may be configured to resist expansion or stretching. The bottom portion 852 may include a nylon fabric (e.g., Kevlar, Dyneema, ripstop fabric, etc.), thermoplastic polyurethane, acrylonitrile butadiene styrene, polyvinyl chloride, polypropylene, high-density polyethylene, polycarbonate, polystyrene, co-polymers thereof, and combinations thereof. The bottom portion 852 may be laminated or coated, for example with urethane, to make the bottom portion 852 impermeable. In some example embodiments, a thickness 855 of the bottom portion 852 may be greater than or equal to about 0.1 mm to less than or equal to about 4.0 mm. In some other example embodiments, the thickness 855 of the bottom portion 852 may be greater than or equal to about 4.0 mm (e.g., when the bottom portion 852 is a part of the protective equipment which the shock absorbing device 800 is configured to contact). In some example embodiments, the top portion 850 and the bottom portion 852 are made from a single sheet of the same material that is folded over or wrapped around the bladder 802.

In the example embodiment of FIGS. 22A-22B, the base wall 814 of the bladder 802 is connected to the bottom portion 852 of the reservoir 804. The bladder 802 may be connected to the bottom portion 852 of the reservoir 804 via stitching, welding (e.g., radiofrequency (RF) welding, heat welding, ultrasonic welding, etc.), adhesives, and/or fasteners (e.g., staples, screws, etc.). In other example embodiments, the bladder 802 is not connected to the bottom portion 852 of the reservoir 804.

In some example embodiments, the first wall 810 of the bladder 802 is connected to the first portion 850 of the reservoir 804. For example, the first wall 810 of the bladder 802 may be connected to the first portion 850 of the reservoir 804 at or near the first impact region 856 of the reservoir 804. The first wall 810 of the bladder 802 may be connected to the first impact region 856 of the reservoir 804 via stitching, welding (e.g., radiofrequency (RF) welding, heat welding, ultrasonic welding, etc.), adhesives, and/or fasteners (e.g., stapes, screws, etc.). The first wall 810 of the bladder 802 and the first impact region 856 of the reservoir 804 may be configured to break apart during impact, such as to absorb a portion of the impact energy.

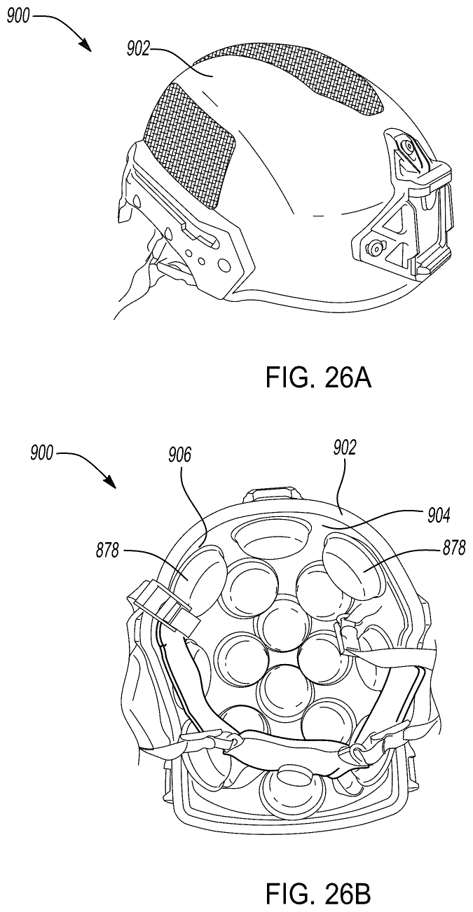

In other example embodiments, the first wall 810 of the bladder 802 is not connected to a portion of the first portion 850 of the reservoir 804. In such examples, the bladder 802 is configured to move independently from and within the reservoir 804. With reference to FIGS. 24A-24B, when the first wall 810 of the bladder 802 is not connected to the top portion 850 of the reservoir 804, the top portion 850 of the reservoir 804 is configured to move relative to the first wall 810 of the bladder 802. In other words, an inner surface 860 of the top portion 850 of the reservoir 804 has a degree of freedom and slips relative to an outer surface 870 of the bladder 802 (e.g., along direction T). In some example embodiments, the relative movement between the top portion 80 of the reservoir 804 and the first wall 810 of the bladder 802 may be less than or equal to about 300% of a dimension 872 of the first impact region 856 of the reservoir 804. Additionally or alternately, the bottom portion 852 of the reservoir 804 may be configured to move relative to the base 814 of the bladder 802.

Relative movement between the top portion 850 of the reservoir 804 and the bladder 802 and/or the bottom portion 852 of the reservoir 804 and the bladder 802 enables the shock absorbing device 800 to absorb impact forces that occur linearly (e.g., along a direction axis A) and tangentially (e.g., along direction B, T, or any other direction relative to axis A). In the example embodiment of FIGS. 24A-24B, the oblique impact force along direction B includes both axial force along direction A and tangential force along direction T. When the shock absorbing device 800 absorbs energy from the oblique impact force along direction B, impact energy in the axial direction A is transferred to the first wall 810 of the bladder 802 while impact energy in the tangential direction B results in lateral movement of the bladder 802 relative to the reservoir 804 along the tangential direction T. The lateral movement (e.g., slip or shear movement) absorbs or redirects impact energy. In this way, the shock absorbing device 800 is configured to absorb axial impact energy (e.g., via spring like behavior of the bladder 802, or damper like behavior caused by flow of internal fluid flow 806 through an orifice 840) and to absorb or redirect tangential energy (e.g., via dampening effect attenuated from lateral movement between the bladder 802 and reservoir 804, or stretching of the top portion 850 of the reservoir 804). Therefore, a shock absorbing device 800 having a bladder 802 and a reservoir 804 that have at least one degree of freedom relative to the other may have improved impact absorbing characteristics as compared to a device without such degree of freedom. A shock absorbing device 800 that is configured to absorb energy from oblique and/or tangential impact forces may be particularly useful in applications like helmets, because rotational velocity and rotational acceleration of the head is associated with the risk of brain injury (e.g., concussions), and may be reduced by wearing helmets having shock absorbing devices 800 that improve attenuation of tangential impact energy. It is contemplated that the degree of freedom previously described between the top portion 850 of the reservoir 804 and the first wall 810 of the bladder 802 could similarly or alternatively exist between the bottom portion 852 of the reservoir 804 and the base wall 814 of the bladder 802. In embodiments where this degree of freedom is applied to both the top portion 850 and the bottom portion 852 of the reservoir 804 and the first wall 810 and base wall 814 of the bladder 802, respectively, additional attenuation or redirection of tangential forces may be afforded due to the increased allowability of slip or shear movement.

Referring back to FIGS. 22A-22B, the first portion 850 and the second portion 852 of the reservoir 804 may be connected at the bond area 854 via stitching, welding (e.g., radiofrequency (RF) welding, heat welding, ultrasonic welding, etc.), adhesives, and/or fasteners (e.g., stapes, screws, etc.). The bond area 854 may form a rigid and/or permanent seal between the first portion 850 and the second portion 852 (e.g., the first portion 850 and the second portion 852 are not configured to separate upon an impact). The bond area 854 may be impermeable. The bond area 854 may have a dimension 823 or thickness that is greater than or equal to about 0.1 mm to less than or equal to about 15 mm.

The internal fluid 806 is preferably a biocompatible fluid. The internal fluid 806 may be a fluid that does not typically cause irritation with skin or eyes of a user. In a preferred example embodiment, the internal fluid 806 does not freeze or evaporate at a temperature where the shock absorbing device 800 would be commonly used. For example, when the shock absorbing device 800 is used in protective helmets or body armor, sports activities may occur at temperatures ranging from −30° C. to 50° C. In military or first responder applications, temperatures may extend to ranges of −50° C. to 70° C. Often, the internal fluid 806 is a liquid, though it is contemplated that the internal fluid 806 may be a gas. The internal fluid may include propylene glycol, mineral oil, and mixtures thereof, although other types of oils are also contemplated. In some embodiments, such as when the shock absorbing device is not used in an application that exhibits temperature fluctuations, the internal fluid 806 may be water. The average total volume of internal fluid 806 in shock absorbing device 800 may be greater than or equal to about 0.1 mL to less than or equal to about 1000 mL. The volume of internal fluid 806 may correspond to a size of the bladder 802 and/or a size of the reservoir 804. The volume of internal fluid 806 may be tailored to achieve the desired shock absorbing characteristics of the device 800.

When the shock absorbing device 800 is in a first or expanded position (FIG. 22A), the internal fluid 806 is positioned within the primary liquid reservoir 816 defined by the bladder 802. In this position, internal fluid 806 may also be disposed within the secondary liquid reservoir 848. Internal fluid 806 in the secondary liquid reservoir 848 may be disposed between the first wall 810 of the bladder and the top portion 850 of the reservoir 804. Internal fluid 806 disposed between the reservoir 804 and the bladder 802 may reduce friction between the reservoir 804 and the bladder 802 and improve or enhance the dampening characteristic of the shock absorbing device 800 when subject to oblique or tangential impact forces (see, e.g., FIGS. 24A-24B).

When an impact is applied to the shock absorbing device 800 (e.g., in an axial direction along axis A), the impact energy to the first impact region 856 of the reservoir 804 transfers to the first wall 810 of the bladder 802. The bladder 802 is configured to collapse into the second position (FIG. 22B). The dimension or height 817 of the bladder 802 is decreased (see, e.g., first or expanded height 891 of FIG. 22A and second or compressed height 817′ of FIG. 22B) as the side wall 812 of the bladder 802 collapses into a compressed position. The bellows 820 of the bladder 802 are configured to resist circumferential expansion while collapsing. In this way, a volume of the primary liquid reservoir 816 is decreased and the internal fluid pressure increases causing internal liquid 806 disposed in the primary liquid reservoir 816 to move to the secondary liquid reservoir 848 via the orifices 840. The top portion 850 of the reservoir expands with the increased pressure from the internal fluid 80. Thus, the shock absorbing device 600 is configured to absorb the impact energy by pushing the internal fluid 806 from the primary liquid reservoir 816 to the secondary liquid reservoir 848. Additional energy may be absorbed by the spring-like behavior of the side wall 812 during collapse and compression. The change or delta in dimension between the shock absorbing device in the first position (FIG. 22A) to the second position (FIG. 22B) may be greater than or equal to about 1.0 mm to less than or equal to about 25.0 mm. In some examples, the dimension may change about 30 % to 95 %.

In some example embodiments, after an impact, the spring-like behavior of the collapsible bladder 802 may cause the bladder 802 to rise or expand back into the first position (FIG. 22A). When the bladder 802 moves back into the first position, the change in pressure in the primary liquid reservoir 816 will suction the internal fluid 806 back from the secondary liquid reservoir 848 into the primary liquid reservoir 816 via the orifices 840. The elasticity of the top portion 850 of the reservoir 804 enables the reservoir 804 to return to its original shape.

In some example embodiments, the shock absorbing device 800 does not recover its original shape until it is manually forced to (e.g., by manually decompressing the reservoir 804 and/or the bladder 802). One way of manually forcing the shock absorbing device 800 to recover its original shape includes pressing the second portion 852 of the reservoir 804 near or around the base wall 814 of the bladder 802 in an axial direction towards the first portion 850 of the reservoir 804. In other example embodiments, the shock absorbing device 800 does not recover its original shape and is suitable for a single-time use.

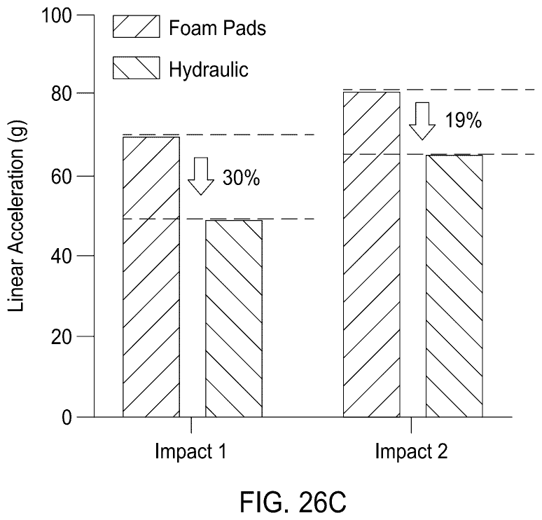

With reference to FIGS. 25A-25C, in some example embodiments, a padding assembly 878 includes the shock absorbing device 800. The padding assembly 878 may include an exterior sleeve 880 and a support structure 882. The exterior sleeve 880 may surround the shock absorbing device 800. The exterior sleeve 880 may be concentric to and circumscribe the reservoir 804. The exterior sleeve 880 may provide desired aesthetic characteristics. The exterior sleeve 880 may improve comfort and wearability of the shock absorbing device 800.

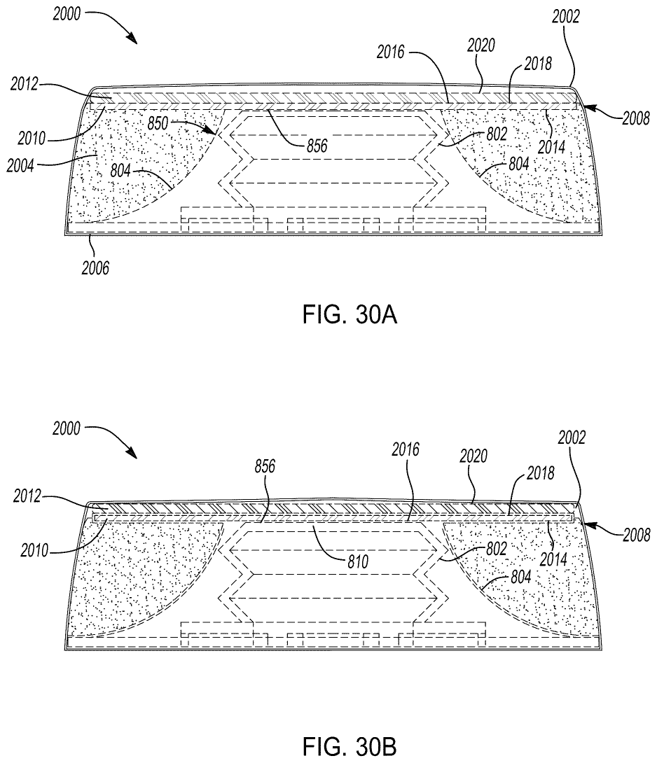

The exterior sleeve 880 may be a polymeric material. The exterior sleeve 880 may include polyurethane, polyurethane-coated fabric, silicon, merino wool, or combinations thereof. The exterior sleeve 880 may have a thickness 884 that is greater than or equal to about 0.1 mm to less than or equal to about 6.0 mm. While the exterior sleeve 880 shown in FIGS. 25A-25C has a generally circular shape, other shapes are contemplated (see, e.g., FIG. 28).

The support structure 882 may be disposed between the exterior sleeve 880 and the reservoir 804. As shown in FIGS. 25A-25C, the exterior sleeve 880 may surround both the support structure 882 and the reservoir 804. In some embodiments, the support structure 882 contacts both the exterior sleeve 880 and the reservoir 804. The support structure 882 may include springs, polymeric materials, air bladders, liquid-filled bladders, foam (e.g., polyurethane, EPP, or EVA foams), or other suitable support and/or padding material. A dimension or thickness 884 of the support structure 882 may be greater than or equal to about 4.0 mm to less than or equal to about 55.0 mm. The shape of the support structure 882 may correspond to a shape of the exterior sleeve 880. In the example embodiment of FIGS. 25A-25C, the support structure 882 has a generally circular or toroidal shape.

As shown in FIG. 25C, the support structure 882 includes an aperture 888 extending therethrough. The support structure 882 may circumscribe the reservoir 804 and the bladder 802. In this way, all or a portion of the reservoir 804 and the bladder 802 may extend at least partially through the aperture 888. All or a portion of the reservoir 804 may contact an inner surface 889 of the support structure 882. The support structure 882 may pre-compress the reservoir 804 in the first position due to compressive forces between the exterior sleeve 880, the support structure 882, and the reservoir 804. (FIG. 25A). The amount of pre-compression may be between about 0% to about 75 % of the first or uncompressed dimension 890 of the reservoir 804.

The support structure 882 may be configured to provide additional comfort to a user of the shock absorbing device 800, for example, when the shock absorbing device is incorporated into sporting equipment such as a helmet. The exterior sleeve 880 and the support structure 882 may cooperate to provide a reduced resting pressure against the user (e.g., against the user's head) as compared to a resting pressure of the shock absorbing device 800 that is free of a support structure 882 and/or exterior sleeve 880. In the example embodiment of FIGS. 25A-25C, the resting pressure against a user may be greater than or equal to about 0.5 kPA to less than or equal to about 77 kPa. The support structure 882 may provide additional impact performance benefits by absorbing impact energy in addition to the impact energy absorbed by shock absorbing device 800.

The exterior sleeve 880 may include a backing 892 that contacts or abuts the bottom portion 850 of the reservoir 804. The exterior sleeve 880 and the backing 892 may be integrally formed. In some example embodiments, the exterior sleeve 880 and the backing 892 may be distinct elements that are joined together (e.g., via welding (e.g., RF, heat, ultrasonic), stitching, adhesives, fasteners, etc.). The backing 892 may be formed from the same material as the exterior sleeve. In other embodiments, the backing 892 may be formed from a different material. In one example embodiment, the backing 892 includes fabric material. In another example embodiment, the backing 892 includes hook-and-loop material. Additionally or alternatively, the backing 892 includes adhesive (e.g., double sided tape). The backing 892 may be configured to facilitate the integration of the shocking absorbing device 800 into a product (e.g., helmet, body armor, car seats, packaging, firearm stocks, backpacks, etc.) by enabling a user to attach the shock absorbing device 800 to the product.

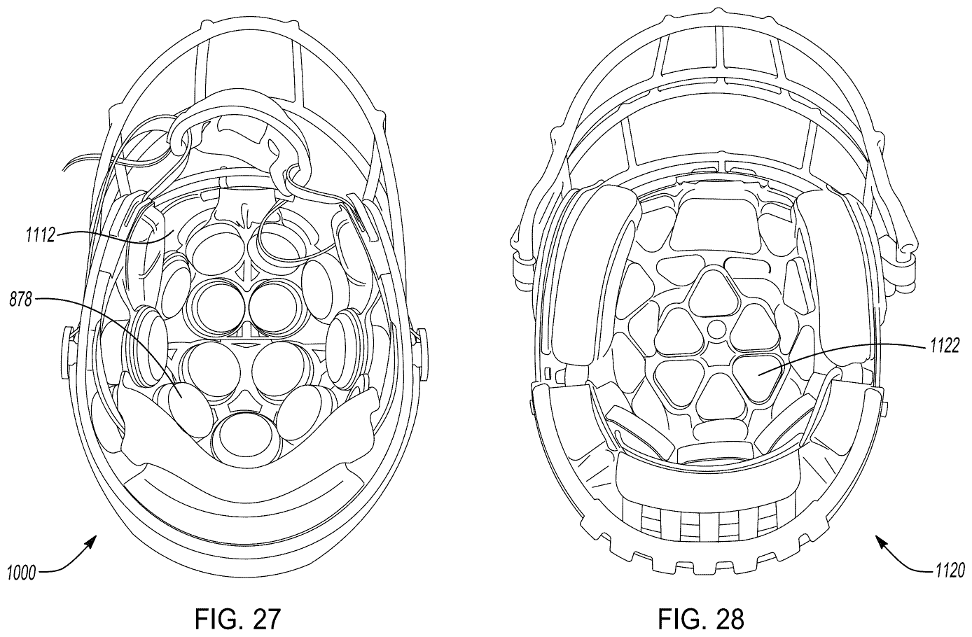

With reference to FIGS. 26A-26B, a device 900 including the shock absorbing device 800 is shown. In the example embodiment of FIGS. 26A-26B, the device 900 is a helmet (also referred to as the “helmet 900”). It is contemplated that the device could be any type of device or equipment that is subject to impact forces (e.g., body armor, car seats, packaging, firearm stocks, backpacks, etc., by way of nonlimiting example). The helmet 900 includes an outer surface 902 and an inner surface 904. A helmet shell 906 may be disposed on the inner surface 904. In some example embodiments, the inner surface comprises the shell 906. The helmet shell 906 may be configured to protect the user from blunt impact (e.g., impact from a collision during a sporting event and/or ballistic impact threats). The helmet shell 906 may be a composite helmet and include one or more materials selected from the group consisting of: Kevlar, fiberglass, carbon fiber, resins, epoxies. The helmet shell 906 may alternatively be a more flexible material and incorporate one or more of the following: high density polyethylene, polycarbonate, acrylonitrile butadiene styrene, or nylon. Any suitable material is contemplated.

One or more padding assemblies 878 may be attached to the helmet shell 906. In some embodiments, the padding assemblies 878 may be directly attached to the helmet shell 906. The padding assemblies 878 may be attached to the helmet shell 906 via hook-and-loop fastening, adhesive, stitching, and/or fasteners. Each of the padding assemblies 878 may include the shock absorbing device 800. In some embodiments, the padding assemblies 878 are the primary energy absorbing feature of the helmet 900 and the helmet is free of other structures that may function to attenuate impact forces. In other embodiments, the helmet 900 may include additional padding and/or structure(s) that are configured to absorb or attenuate impact forces. The padding assemblies 878 in the helmet 900 may reduce an amount of impact force received by a user's head while also improving the comfort and fit of the helmet 900.

FIG. 26C shows impact testing results from a conventional helmet that included foam pads (i.e., was free of padding assemblies 878) compared to the helmet 900 including padding assemblies 878 having the shock absorbing devices 800. The impact tests are performed according to the AR-PD 10/02 test protocol, which describes impact test methodologies for ballistic shell helmets for the United States Army. The helmets are mounted to a headform and dropped onto a hemispherical steel anvil at a velocity of 10 feet per second. Two successive impact tests are conducted on each helmet. An accelerometer is placed in the center of gravity of the headform to measure the peak linear acceleration of a head resulting from drop impact. Lower accelerations of the head are associated with a reduced risk of head injuries (e.g., skull fractures) and/or traumatic brain injuries (e.g., concussions). Drop impacts are conducted to the crown (top) of the helmet. As shown in FIG. 26C, the helmet 900 including padding assemblies 878 (labeled as “Hydraulic”) yields a linear acceleration that is 30% lower than the helmet having traditional foam pads on a first impact. On a second impact, the helmet 900 including padding assemblies 878 yields a linear acceleration that is 19% lower than the helmet having traditional foam pads.

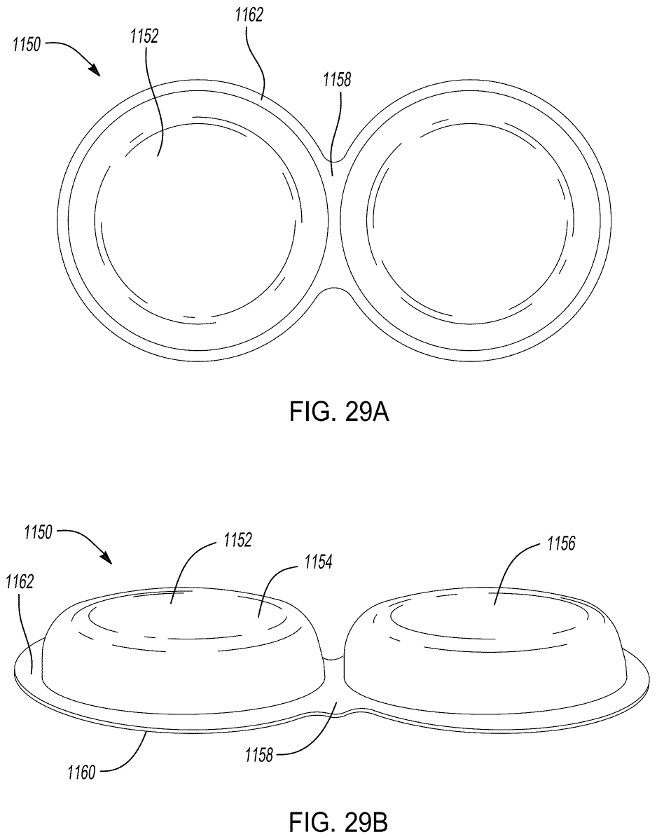

The shape, size, and configuration of the padding assembly 878 may be tailored to achieve the desired impact absorption and user comfort characteristics. With reference to FIG. 27, a helmet 1000 including a plurality of padding assemblies 878 is shown. Each of the padding assemblies may have a different dimension or height 1110 (see, FIG. 25A). In this way, varying the height 1110 of each of the padding assemblies 878 may accommodate different levels of impact protection to different areas of the helmet 1000 and/or improve the fit of the helmet on the user.

The padding assemblies 878 may be indirectly attached to the helmet 1000, such as via an intermediate layer 1112 disposed in the helmet. The intermediate layer 1112 may be a polymeric material. The intermediate layer 1112 may include expanded polystyrene, expanded polypropylene, air-filled dampers, viscoelastic foams, hydraulic shock absorbers, buckling beams, bucking cones, lattice (e.g., 3D printed lattices), and combinations thereof. Other materials and structures are also contemplated. In the example embodiment of FIG. 26, the intermediate layer 1112 may be the primary energy absorbing structure in the helmet 1000 and the padding assemblies 878 may cooperate with the intermediate layer 1112 as secondary energy absorbing structures.

With reference to FIG. 28, a helmet 1120 includes a plurality of padding assemblies 1122 attached thereto. The plurality of padding assemblies 1122 may be the same as or similar to the padding assemblies 878 of FIGS. 25-27, except that each of the padding assemblies 1122 have a substantially triangular shape. Each of the padding assemblies 1122 including the shock absorbing device 800.

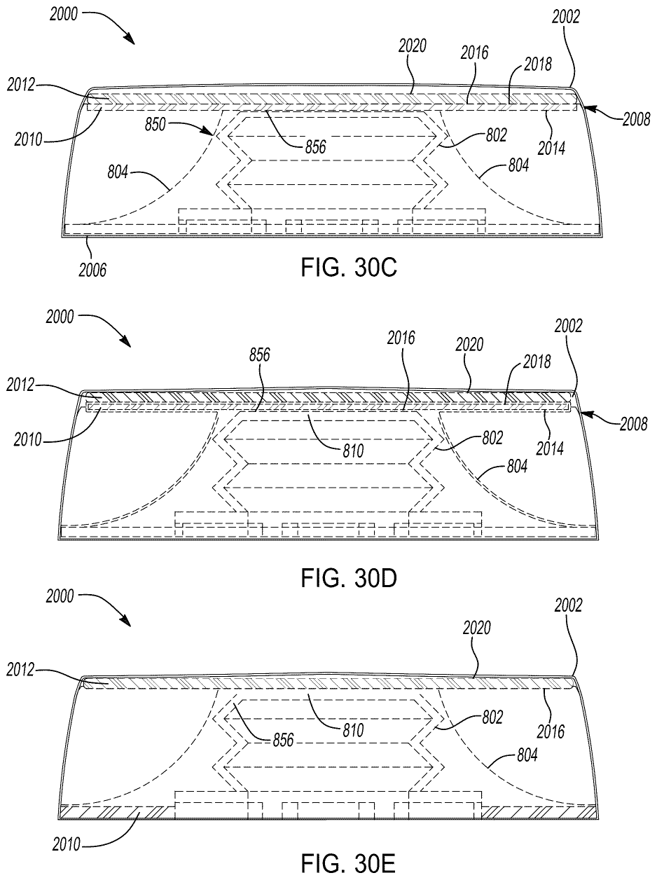

Referring to FIGS. 29A-29B, a padding assembly 1150 is shown. The padding assembly 1150 may be the same as or similar to the padding assembly 878 of FIGS. 25-27 except as otherwise described below. The padding assembly 1150 includes two or more shock absorbing devices 800. The padding assembly 1150 includes an exterior sleeve 1152 that encompasses or surrounds the two or more shock absorbing devices 800. The exterior sleeve 1152 may have a first protrusion 1154 that surrounds one of the shock absorbing devices 800 (not shown) and a second protrusion 1156 that surrounds the other of the shock absorbing devices 800 (not shown). The first protrusion 1154 and the second protrusion 1156 connect at connect region 1158 in between the first protrusion 1154 and the second protrusion 1156. The first protrusion 1154, the second protrusion 1156, and the connect region 1158 may be integrally formed. It is contemplated that the number of protrusions and connect regions of the exterior sleeve 1152 correspond to the number of shock absorbing devices 800 in the padding assembly 1150. There may be more than two shock absorbing devices and consequently more than two protrusions in the padding assembly 1150. Alternatively, some embodiments may feature protrusions that include one or more shock absorbing devices, while others include no shock absorbing devices (e.g., filled with a foam or other material).

The padding assembly 1150 may include two or more support structures (not shown, see, e.g., support structures 882). A first support structure may circumscribe the reservoir 804 and/or bladder 802 (not shown) of the first shock absorbing device 800 and a second support structure may circumscribe the reservoir 804 and/or bladder 802 (not shown) of the second shock absorbing device 800. The number of support structures may correspond to the number of shock absorbing devices 800 disposed in the padding assembly 1150.

A backing 1160 is disposed adjacent to and extending between the second portion (not shown) of the reservoir (not shown) of the first shock absorbing device 800 and the second portion (not shown) of the reservoir (not shown) of the second shock absorbing device. The backing 1160 and the exterior sleeve 1152 cooperate to define a rim 1162 extending around a perimeter of the padding assembly 1150.

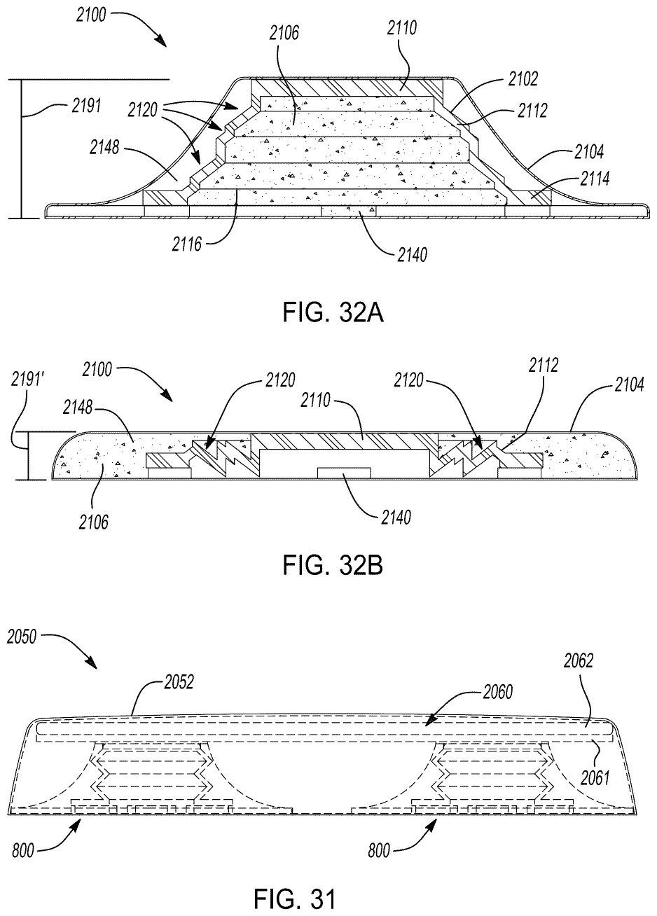

With reference to FIGS. 30A-30E, another padding assembly 2000 is shown. The padding assembly 2000 includes the shock absorbing device 800. The padding assembly 2000 may be the same as or similar to the padding assemblies 878, 1122, and/or 1150 except as otherwise described below. The padding assembly 2000 may include an exterior sleeve 2002, a support structure 2004, and a backing 2006 (FIGS. 30A-30B). In some embodiments, the padding assembly 2000 is free of the support structure 2004 (FIGS. 30C-30E). The padding assembly further includes a support element 2008. The support element 2008 may be disposed between the top portion 810 of the bladder 802 of the shock absorbing device 800 and the exterior sleeve 2002.

The support element 2008 may include a plate 2010 and a pad 2012. The plate 2010 may be a rigid material. The plate 2010 may be a polymeric material (e.g., acrylonitrile butadiene styrene). The plate 2010 may include a dense or stiff foam (e.g., expanded polystyrene). The plate 2010 may be a metal. The plate 2010 may be a composite (e.g., a fiber reinforced composite). The plate 2010 extends between a first surface 2014 and an opposite second surface 2016. A thickness of the plate between the first surface 2014 and the second surface 2016 may be greater than or equal to about 0.1 mm to less than or equal to about 15.0 mm.

The pad 2012 may be configured to be a cushion, such as to provide increased comfort to the user. The pad 2012 may be a foam. The pad 2012 may include polyurethane foam, expanded polypropylene, vinyl nitrile foam, a lattice material (e.g., a 3D printed lattice), a hydraulic or liquid-filled pad, an air bladder, etc. The pad 2012 may include a viscoelastic material. The pad 2012 extends between a first surface 2018 and an opposite second surface 2020. A thickness of the pad 2012 between the first surface 2018 and the second surface 2020 may be greater than or equal to about 0.1 mm to less than or equal to about 25.0 mm.

The first surface 2018 of the pad 2012 may be disposed on the second surface 2016 of the plate 2010. In the example embodiments of FIGS. 30A and 30C, the pad 2012 is directly affixed to the plate 2010. The pad 2012 may be attached or fixed to the plate 2010 via stitching, welding (e.g., RF, ultrasonic, heat welding, etc.), adhesives (e.g., glue, double sided tape, etc.) and/or fasteners. In some example embodiments, the pad 2012 is not attached to the plate 2010. The pad 2012 may be attached or fixed to the exterior sleeve 2002 via stitching, welding (e.g., RF, ultrasonic, heat welding, etc.), and/or fasteners. In some example embodiments, the pad 2012 is not attached to the exterior sleeve 2002.

A surface area of the plate 2010 may be greater than a surface area of the top wall of the bladder 302. The surface area of the plate 2010 may be greater than a surface area of the impact region 856 of the reservoir 804. The surface area of the plate 2010 may be 50% to 100% of the surface area of the exterior sleeve 2002. Similarly, a surface area of the pad 2012 may be greater than the surface area of the top wall 810 of the bladder 802 and/or the first impact region 856 of the reservoir 804. The surface area of the pad 2012 may be 50% to 100% of the surface area of the exterior sleeve 2002. The support element 2008 is configured to distribute the load pressure applied to the padding assembly 2000 and shock absorbing device 800. In this way, even when an impact force is not applied locally to the shock absorbing device 800 (e.g., the impact force would be transmitted to the support structure 2004), the load is distributed to the shock absorbing device 800 via the support element 2008. While the example embodiment shown in FIGS. 30A-30B shows plate 2010 and pad 2012 that are formed of different materials, it is contemplated that in other example embodiments the support element 2008 includes only one layer of material that is configured to function as both the plate and the pad (i.e., distribute impact energy to the shock absorbing device 800 and improve the comfort of the user). Additionally, the pad 2012 may further absorb impact energy through its compression on impact in combination with the compression of the shock absorber 800. In some example embodiments, the plate 2010 may absorb impact energy by breaking or flexing upon impact.

As shown in FIGS. 30A and 30C, the support element 2008 may be positioned external to the reservoir 804. The first surface 2014 of the plate 2010 may be disposed adjacent the top impact region 856 of the reservoir and the second surface 2020 of the pad 2012 may be disposed adjacent the exterior sleeve 2002. The support element 2008 may be attached to at least one of the exterior sleeve 2002 or the shock absorbing device 800 (e.g., is attached to one or both or the exterior sleeve 2002 and/or the reservoir 804).

As shown in FIGS. 30B and 30D, the plate 2010 of the support element 2008 may be positioned within the reservoir 804 and disposed between the bladder 802 and the reservoir 804. The first surface 2014 of the plate 2010 may be disposed on the first wall 810 of the bladder 802. In one example embodiment, the plate 2010 is attached to the bladder 802 via stitching, welding (e.g., RF, ultrasonic, heat welding, etc.), adhesive (e.g., glue, double sided tape, etc.) and/or fasteners. In another example embodiment, the plate 2010 is not attached to the bladder 802. The pad 2012 may be spaced apart from the plate 2010. The pad 2012 may be positioned outside of the reservoir 804 and disposed between the reservoir 804 and the exterior sleeve 2002.

As shown in FIG. 30E, the plate 2010 of the support element 2008 may be positioned adjacent the second portion 852 of the reservoir 804. It is contemplated that the support element 2008 may include a first plate positioned adjacent the top portion 850 of the reservoir 804 and a second plate positioned adjacent the bottom portion 852 of the reservoir 804. Additionally or alternately, the support element 2008 may include a first plate adjacent the top wall 810 of the bladder 802 and a second plate positioned adjacent the bottom portion 852 of the reservoir 804.

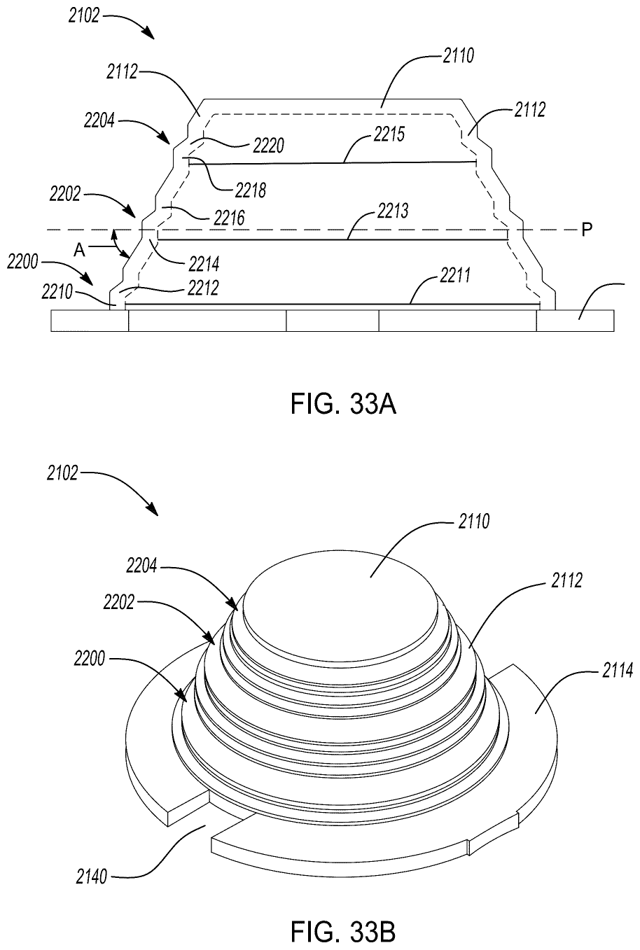

With reference to FIG. 31, a padding assembly 2050 is shown. The padding assembly 2050 includes two or more shock absorbing devices 800. The padding assembly 2050 includes an exterior sleeve 2052 that surrounds or encompasses the two or more shock absorbing devices 800. It is contemplated that more than two shock absorbing devices 800 may be encompassed by a single exterior sleeve 2052. In the example embodiment of FIG. 31, the padding assembly is free of a support structure, but it is contemplated that a support structure similar to support structure 882 may surround the two or more shock absorbing devices 800 and be disposed between the shock absorbing devices and the exterior sleeve 2052.

The padding assembly may include a support element 2060. The support element 2060 may be the same as or similar to the support element 2008 of FIGS. 30A-30B, except that the support element 2060 covers both of the two shock absorbing devices 800. The support element 2060 may include a plate 2061 and a pad 2062. The exterior sleeve 2052 surrounds the shock absorbing devices 800 and the support element 2060. When an impact force is applied to the padding assembly 2050, the support element 2060 may be configured to distribute the impact force to each of the shock absorbing devices 800, rather than just to a single shock absorbing device or to a space in between two shock absorbing devices (i.e., neither shock absorbing device).

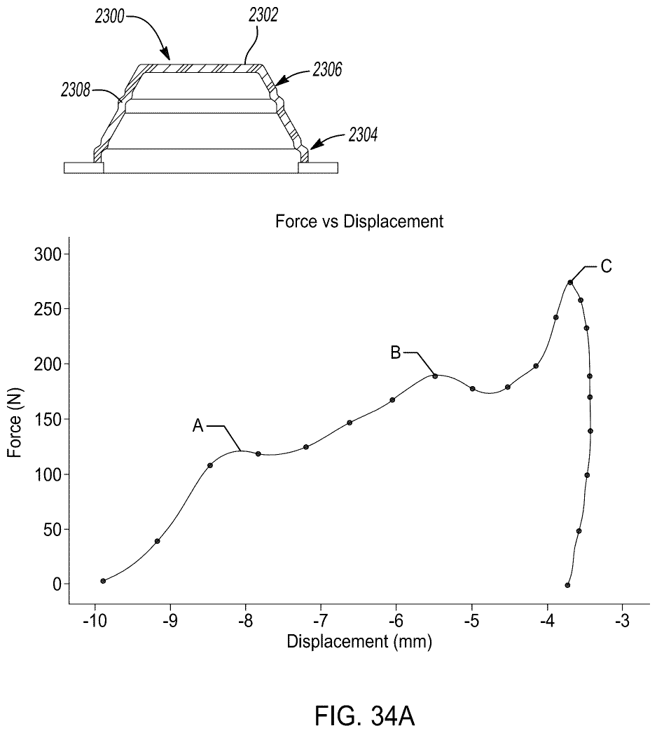

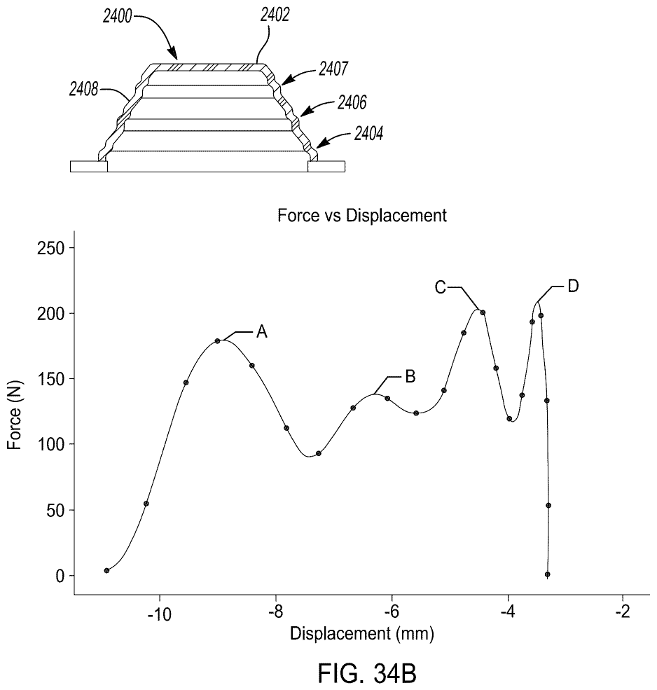

With reference to FIGS. 32A-32B and 33A-33B, another shock absorbing device 2100 is shown. The shock absorbing device 2100 may be the same as or similar to the shock absorbing device 800 except as otherwise described below. The shock absorbing device 2100 includes a first contiguous membrane or bladder 2102, a second contiguous membrane or reservoir 2104, and internal fluid 2106. The bladder 2102 may include a first or top wall 2110, a second or side wall 2112, and a third or base wall 2114 that cooperate to define a primary liquid reservoir 2116 therebetween. In a first or uncompressed position (FIG. 32A), the internal fluid 2106 is disposed within the primary collection reservoir 2116. In the example embodiment of FIGS. 32A-32B, the bladder 2102 may have a generally conical or pyramidal cross-section.

The side wall 2112 may include collapsible features 2120. In the example embodiment of FIGS. 32A-32B and 33A-3B, the collapsible features 2120 are discrete steps (also referred to as the “discrete steps 2120”). As best shown in FIG. 33B, bladder 2102 includes a first step 2200, a second step 2202, and a third step 2204. The first step includes an axially extending wall 2210 and an angled wall 2212. The second step 2202 includes an axially extending wall 2214 and an angled wall 2216. The third step 2204 includes an axially extending wall 2218 and an angled wall 2220. A first diameter 2211 of the first step 2200 (e.g., a diameter defined by axially extending wall 2210) may be greater than a second diameter 2213 of the second step 2202, which may be greater than a third diameter 2215 of the third step 2204. The axially extending wall 2210 of the first step 2200 is connected to the axially extending wall 2214 of the second step 2202 by the angled wall 2212. Similarly, the axially extending wall 2214 of the second step 2202 is connected to the axially extending wall 2218 of the third step 2204 by the angled wall 2216. Each of the angled walls may extend at an angle A relative to a plane P of the bladder 2102. The angle may be greater than or equal to about 10 degrees to less than or equal to about 80 degrees. A thickness of the side wall, height of the steps 2120, and angle A of the steps may be tailored and varied to achieve the desired impact absorption characteristics of the bladder 2102.

The bladder 2102 defines one or more orifices 2140 extending therethrough. Internal fluid 2106 may be configured to flow through orifices 2140 during compression of bladder 2102 and collapse of the side wall 2112.

The reservoir 2104 may at least partially surround the bladder 2102. The reservoir 2104 and the bladder 2102 cooperate to define a secondary liquid reservoir 2148 that is in fluid communication with the primary liquid reservoir 2116. The reservoir 2104 may include a first or top portion 2150 and a second or bottom portion 2152. The first portion 2150 and the second portion 2152 may join or connect at a bond area 2154.

As best shown in FIG. 32B, when an impact force is applied to the shock absorbing device 2100, impact energy from the reservoir 2104 transfers to the bladder 2102. The bladder 2102 is configured to collapse into the second position. The side wall 2112 collapses via the discrete steps 2120. A change in dimension or height 2191 of the shock absorbing device 2100 between the first position (FIG. 32A) and the second position (see 2191′ of FIG. 32B) may be greater than the change in dimension than the shock absorbing device 800 including bellows 820 (see, e.g., FIG. 22A-B).

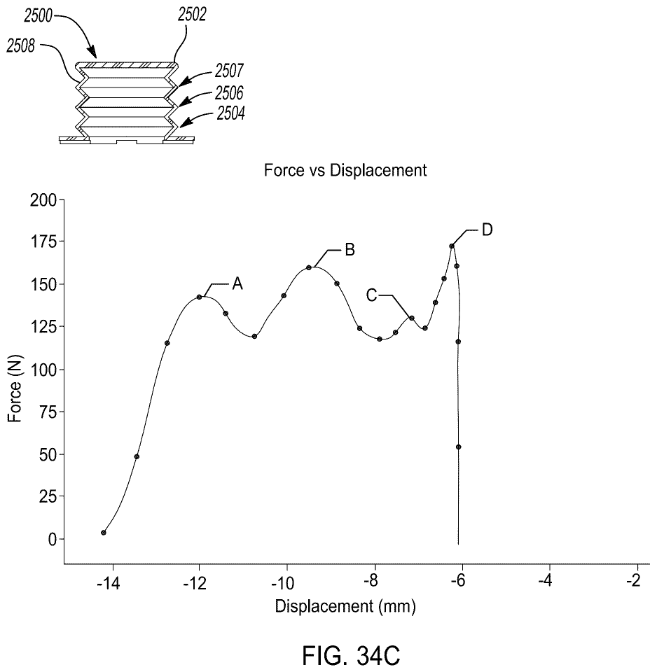

With reference to FIGS. 34A-3C, graphs of impact force versus displacement of the a shock absorbing device are shown. The force on the y-axis represents the force measured by a load cell placed directly beneath a shock absorber. The shock absorber is impacted by a dropping mass. A high-speed video camera tracks the amount of compression of the shock absorber along the x-axis. The farther left point on the force displacement curve represents the initial contact point of the impact mass at the shock absorber's full height (represented in negative numbers). The zero point on the x-axis represents the point where the bottom of the shock absorber makes contact with the load cell. The plotted line in the plots tracks the amount of force experienced by the load cell as it corresponds to the amount of compression of the shock absorber.

FIG. 34A is a force versus displacement curve of a shock absorbing device 2300 including a bladder 2302 having collapsable features that include a first discrete step 2304 and a second discrete step 2306. The shock absorbing device 2300 has a total height of approximately 10 mm. Due to the use of the collapsible features 2304, 2306, the shock absorbing device is able to utilize 6.5 mm of its stroke (approximately 65%). In the force-displacement plot, a collapse A of the second step 2306 occurs at a force of approximately 125 N. A collapse B of the first step 2304 occurs at a force of approximately 190 N. When side walls 2308 fully collapse and internal fluid (not shown) is forced from the primary liquid reservoir to the secondary liquid reservoir, a bottom-out will occur in which the remaining impact force is attenuated by compression of side wall 2308, observed at point C at approximately 275 N. When bottom-out occurs, force will spike quickly with small changes in displacement. Tuning the number, shape, and configuration of the discrete steps may avoid a high bottom-out peak force which reduces the peak force of an impact. While conventional foam materials have force efficiency values of approximately 30%, a shock absorbing device 2300 including collapsible bladder 2302 has an improved force efficiency of approximately 43.7%. A higher force efficiency indicates an improved ability to attenuate force, especially within a confined space.

FIG. 34B is a force versus displacement curve of another shock absorbing device 2400 including a bladder 2402 having collapsable features that include a first discrete step 2404, a second discrete step 2406, and a third discrete step 2407. The shock absorbing device 2400 has a total height of approximately 11 mm. Due to the use of the collapsible features 2404, 2406, 2407, the shock absorbing device is able to utilize 7.5 mm of its stroke (approximately 68%). In the force-displacement plot, a collapse A of the third step 2407 occurs at a force of approximately 175 N. A collapse B of the second step 2406 occurs at a force of approximately 135 N. A collapse C of the first step 2404 occurs at a force of approximately 205 N. When side walls 2408 fully collapse and internal fluid (not shown) is forced from the primary liquid reservoir to the secondary liquid reservoir, a bottom-out will occur in which the remaining impact force is attenuated by compression of side wall 2408, observed at point D at approximately 210 N. The shock absorbing device 2400 including collapsible bladder 2402 has an improved force efficiency of approximately 49.1% as compared to the force efficiency of collapsible bladder 2303 of FIG. 34A. Accordingly, the number, size, and configuration of collapsible features may be tailored to achieve the desired force efficiency characteristics of the shock absorbing device.

FIG. 34C is a force versus displacement curve of another shock absorbing device 2500 including a bladder 2502 having collapsible features that include a first bellow 2504, a second bellow 2506, and a third bellow 2507. The shock absorbing device 2500 has a total height of approximately 14 mm. Due to the use of the collapsible features 2504, 2506, 2507, the shock absorbing device is able to utilize 8 mm of its stroke (approximately 57%). In the force-displacement plot, a collapse A of the third bellow 2507 occurs at a force of approximately 140 N. A collapse B of the second bellow 2506 occurs at a force of approximately 150 N. A collapse C of the first bellow 2506 occurs at a force of approximately 130 N. When side walls 2508 fully collapse and internal fluid (not shown) is forced from the primary liquid reservoir to the secondary liquid reservoir, a bottom-out will occur in which the remaining impact force is attenuated by compression of side wall 2508, observed at point D at approximately 170 N. The shock absorbing device 2500 including collapsible bladder 2502 has a force efficiency of approximately 47.8%. Accordingly, the number, size, and configuration of collapsible features may be tailored to achieve the desired force efficiency characteristics of the shock absorbing device.

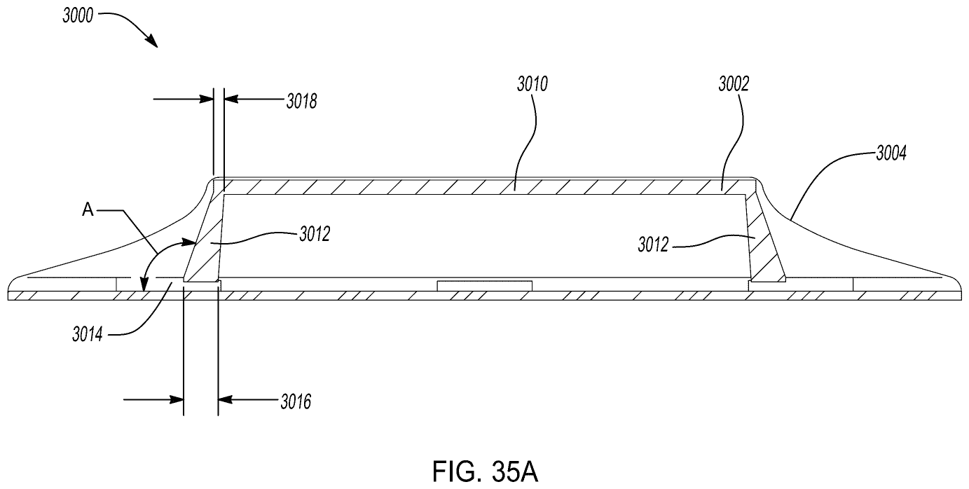

With reference to FIGS. 35A-35D another shock absorbing device 3000 is shown. The shock absorbing device 3000 may be the same as shock absorbing devices 800, 2100, 2300, 2400, and/or 2500 except as otherwise described below. Shock absorbing device 3000 includes a bladder 3002, a reservoir 3004, and internal fluid (not shown).

The bladder 3002 includes a first or top wall 3010, side wall 3012, and base wall 3014. The side wall 3012 defines a varying thickness. A first thickness 3016 is defined near the base wall 3014 and a second thickness 3018 is defined near the top wall 3010. The thickness may be tapered or decrease from the base wall 3014 towards the top wall 3010. In other words, thickness 3016 is greater than thickness 2018. The side wall 3012 may extend from the base wall 3014 to the top wall 3010 at an angle A relative to the base wall 3014 of the bladder 3002. The angle A may be tailored to achieve the desired impact absorption characteristics.

The side wall 3012 may be free of collapsible features like bellows and/or discrete steps. Instead, the side wall 3012 and the top wall 3010 may cooperate to buckle when subject to an impact force. In this way, the side wall 3012 resists compression and circumferential expansion while the top wall 3010 is compressed axially downward. A first portion 3020 (FIGS. 35B and 35D) of the side wall 3012 above a buckle point 3021 may fold in on itself during compression. A second portion 3022 of the side wall 3012 beneath the buckle point 3021 may remain uncollapsed. The second portion 3022 of side wall 3012 which remains uncollapsed may continue to provide resistance to circumferential expansion as internal fluid flows through one or more orifices. Because the second portion 3022 of the side wall 3012 is thicker than the first portion 3020, it may provide relatively improved resistance to circumferential expansion. The buckle point 3021 may be tailored based on the thickness and height of the side wall 3012 to achieve the desired impact absorption characteristics. For example, the buckling point 8021 may be designed such that after the side wall 3012 buckles, the top wall 3010 of the bladder 3002 contacts or nearly contacts the bottom portion of the reservoir 3004. In this way, the volume of the bladder 3002 decreases in the compressed state (FIG. 35B). While the bladder 3002 of FIGS. 35A-35D is shaped like a truncated cone, other shapes and configurations are contemplated. When bladder 3002 is in the second or collapsed position (FIGS. 35B and 35D), internal fluid from a primary liquid reservoir is forced through orifices 3040 of the bladder 3002 to a secondary liquid reservoir.

In addition to impact force attenuation, the bladder 3002 may have additional benefits such as easier and more efficient manufacturing. This increased ease of manufacturing may be afforded by the reduced intricacy required to design and manufacture tooling (e.g., as compared to a bladder having bellows or discrete steps). In one example, the bladder 3002 may be injection molded. In another example, the bladder 3002 may be thermoformed.

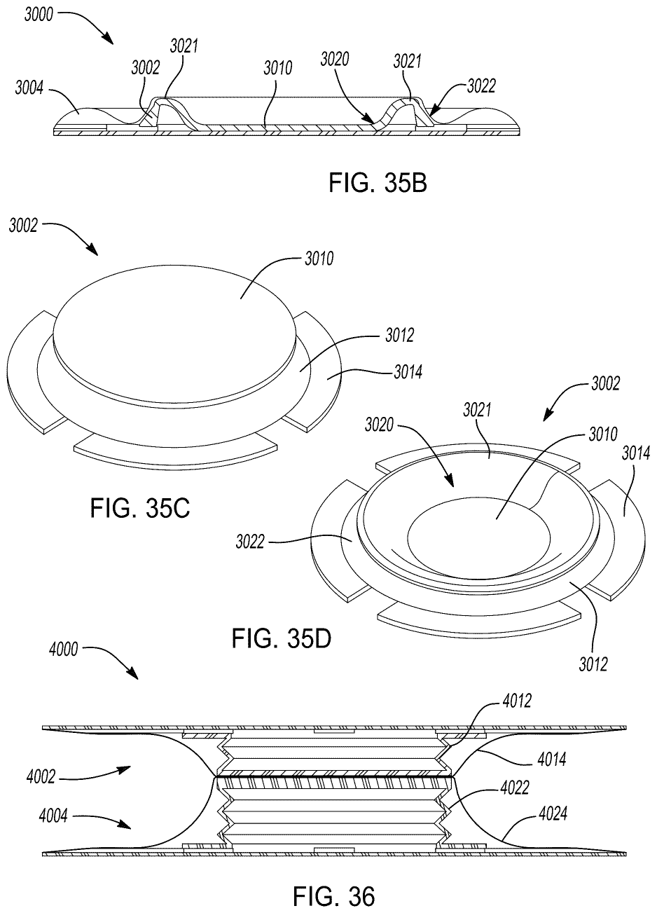

With reference to FIG. 36, a shock absorbing device 4000 is shown. The shock absorbing device 4000 may include a first shock absorbing device 4002 and a second shock absorbing device 4004. Each of the first and second shock absorbing devices 4002, 4004 may be the same as or similar to shock absorbing devices 800, 2100, 2400, 2500, 2600, and/or 3000 except as otherwise described below. The first shock absorbing device 4002 and the second shock absorbing device 4004 may cooperate in series.

The first shock absorbing device 4002 includes a bladder 4012, a reservoir 4014, and internal fluid (not shown). The second shock absorbing device 4004 includes a bladder 4022, a reservoir 4024, and internal fluid (not shown). The reservoir 4014 of the first shock absorbing device 4002 may be connected or disposed adjacent to the reservoir 4024 of the second shock absorbing device 4004. In the example embodiment of FIG. 36, the reservoir 4014 and the reservoir 4024 are attached via glue, adhesive, tape, stitches, one or more fasteners, or welding (RF weld, ultrasonic weld, heat weld), etc. It is also contemplated that the reservoir 4014 and the reservoir 4024 are in contact without being attached. The bladders 4012 and 4022 are spaced apart from the respective reservoirs 4014, 4024 such that each bladder 4012, 4022 has a degree of freedom relative to the respective reservoir 4014, 4024 (e.g., can move in a tangential direction relative to the reservoir 4014, 4024).

The first and second shock absorbing devices 4002, 4004 may be identical. However, it is contemplated that features of the first shock absorbing device 4002 and the second shock absorbing device 4004 are different. For example, the first shock absorbing device 4002 and the second shock absorbing device 4004 may have different shapes, collapsible features, dimensions, etc., to tune the impact absorption characteristics of the shock absorbing device 4000. In one example, the first shock absorbing device 4002 may be configured to collapse in response to a low mass, low velocity impact while the second shock absorbing device 4004 may be configured to collapse in response to a high mass, high velocity impact.

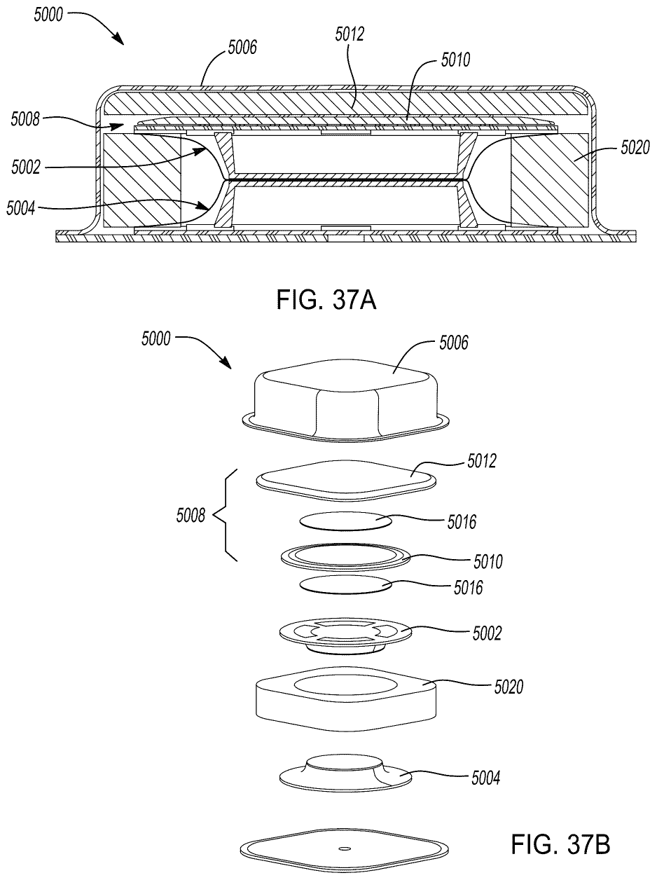

With reference to FIGS. 37A-37B, another padding assembly 5000 is shown. The padding assembly 5000 may include a first shock absorbing device 5002 and a second shock absorbing device 5004. In the example embodiment of 37A-37B, the first and second shock absorbing devices 5002, 5004 are the same as or similar to shock absorbing device 3000 of FIGS. 35A-35D and/or devices 4002, 4004 of FIG. 36 except as otherwise described below.

The padding assembly 5000 includes an exterior sleeve 5006 that surrounds one or both of the shock absorbing devices 5002, 5004. The padding assembly 5000 may include a support element 5008 disposed adjacent one or both of the shock absorbing devices 5002, 5004. The support element 5008 may include a plate 5010 and a pad 5012. The plate 5010 is configured to distribute force evenly across it and direct impact force to one or both of the shock absorbing devices 5002, 5004. In some example embodiments, the plate 5010 may be attached to one or both of the shock absorbing devices 5002, 5004. The pad 5012 may be configured to provide additional comfort to a user and to absorb a portion of the impact energy. Connectors 5016 may be configured to attach the plate 5010 to the pad 5012, the pad 5012 to the exterior sleeve 5006, and/or the plate 5010 and/or pad 5012 to one or both of the shock absorbing devices 5002, 5004. The connectors 5016 may be an adhesive film, tape, glue, or other fastener. A support structure 5020 may surround the shock absorbing devices 5002, 5004. The exterior sleeve 5006 may surround the shock absorbing devices 5002, 5004, plate 5010, pad 5012, and support structure 5020. The pad 5012 may be positioned between the plate 5010 and exterior sleeve 5006. Additional plates 5010, pads 5012, and/or shock absorbing devices 5002, 5004 may be included in the padding assembly and surrounded by the exterior sleeve 5006.

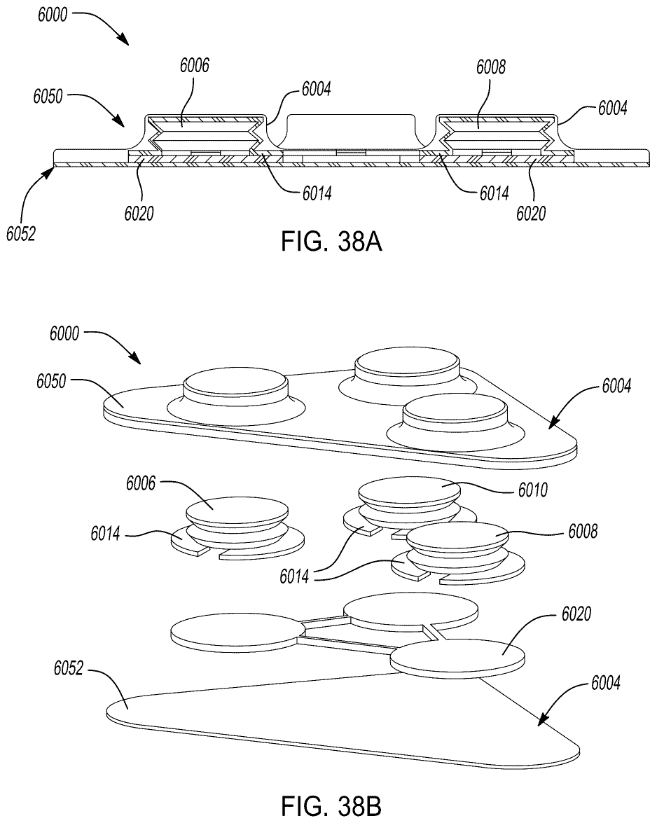

With reference to FIGS. 38A-38B, another shock absorbing device 6000 is shown. The shock absorbing device includes two or more bladders disposed within one reservoir 6004. As shown in FIGS. 38A-38B, the shock absorbing device 6000 includes a first bladder 6006, a second bladder 6008, and a third bladder 6010 all surrounded by the reservoir 6004. The bladders 6006, 6008, 6010 may be connected via a common base 6020. The base 6020 may attach to the bladders 6006, 6008, 6010 at their respective base walls 6014. The base 6020 may be configured to maintain the positioning of the bladders 6006, 6008, 6010 relative to one another during an impact (i.e. fix the bladders relative to one another). The base 6020 include a fabric, a polymeric material, a composite material, a metal, or any other suitable material. The reservoir 6004 includes a top portion 6050 and a bottom portion 6052 that are configured to be joined or sealed together.

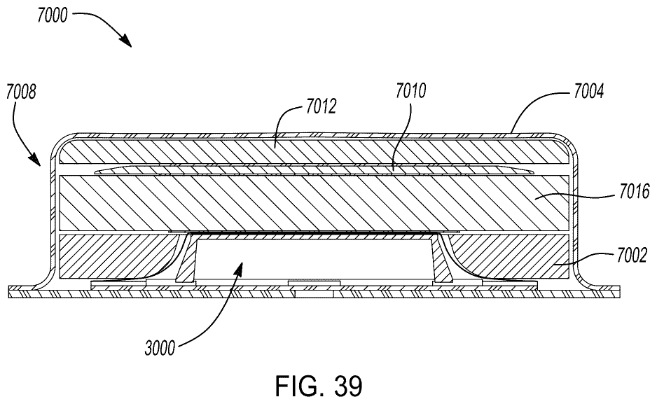

With reference to FIG. 39, another padding assembly 7000 is shown. The padding assembly 7000 includes a shock absorbing device. In the example embodiment of FIG. 39, the padding assembly 7000 includes the shock absorbing device 3000. The padding assembly includes a support structure 7002 surrounding the shock absorbing device 3000. An exterior sleeve 7004 surrounds the support structure 7002 and the shock absorbing device 3000. A support element 7008 including a plate 7010 and a pad 7012 is disposed between the shock absorbing device 3000 and the exterior sleeve 7004.

The padding assembly 7000 further includes a member 7016. The member 7016 is positioned between the shock absorbing device 3000 and the exterior sleeve 7004. In one example embodiment, the member 7016 is positioned between the shock absorbing device 3000 and the plate 7010 of the support element 7008. The member 7016 may include foam (e.g., expanded polypropylene, vinyl nitrile, expanded polystyrene, polyurethane, ethyl vinyl acetate, etc.), a lattice structure, a honeycomb structure, or an air bladder. The member 7016 may be configured to attenuate impact energy in conjunction with the shock absorbing device 3000. While FIG. 39 shows member 7016 positioned adjacent the top portion of the reservoir, it is contemplated that the member 7016 is positioned adjacent the second or base portion of the reservoir. In one example, the member 7016 is configured to attenuate impacts of about 20 J energy while the shock absorbing device is configured to attenuate impacts of about 60 J energy.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shock absorbing device comprising:
a first contiguous membrane defining a primary liquid reservoir containing a liquid, the first contiguous membrane including at least one collapsible feature; and
a second contiguous membrane surrounding the first contiguous membrane and defining a secondary liquid reservoir fluidly connected to the primary liquid reservoir through an orifice, the second contiguous membrane being impermeable,
wherein in a first state, the first contiguous membrane is in a first expanded position and in a second state the first contiguous membrane is in a second compressed position, and
wherein the first contiguous membrane is compressible upon an impact thereby transferring the liquid from the primary liquid reservoir through the orifice to the secondary liquid reservoir and dissipating the impact.

2. The shock absorbing device of claim 1, wherein the first contiguous membrane is configured to resist circumferential expansion upon an impact.

3. The shock absorbing device of claim 1, wherein the second contiguous membrane has a degree of freedom relative to a first wall of the first contiguous membrane.

4. The shock absorbing device of claim 1, wherein the second contiguous membrane is configured to reversibly deform upon an impact.

5. The shock absorbing device of claim 1, wherein the first contiguous membrane and the second contiguous membrane cooperate to dissipate an impact in an axial direction and a tangential direction.

6. The shock absorbing device of claim 1, wherein the first contiguous membrane is reversibly compressible between the first state and the second state.

7. The shock absorbing device of claim 1, wherein the at least one collapsible feature is a plurality of bellows.

8. The shock absorbing device of claim 7, wherein each of the bellows comprise a first wall and a second wall extending at an angle relative to a plane of the bellows that is greater than or equal to about 100 degrees to less than or equal to about 160 degrees.

9. The shock absorbing device of claim 1, wherein the at least one collapsible feature is a plurality of discrete steps.

10. The shock absorbing device of claim 9, wherein each of the discrete steps comprises an axially extending wall and an angled wall, the angled wall connecting a first axially extending wall of a first step and a second axially extending wall of a second step, and wherein a first diameter defined by the first axially extending wall is greater than a second diameter defined by the second axially extending wall.

11. The shock absorbing device of claim 10, wherein each of the angled walls extend at an angle that is greater than or equal to about 10 degrees to less than or equal to about 80 degrees.

12. The shock absorbing device of claim 1, wherein the first contiguous membrane comprises a first wall, a side wall, and a base wall, wherein a first thickness of the side wall adjacent the base wall is greater than a second thickness of the side wall adjacent the first wall.

13. The shock absorbing device of claim 12, wherein the at least one collapsible feature is a buckle point positioned between the first wall and the base wall, wherein a first portion of the side wall is configured to collapse and a second portion of the side wall is not configured to collapse.

14. The shock absorbing device of claim 1, further comprising a plate adjacent to a first wall of the first contiguous membrane, wherein the plate is configured to absorb at least a portion of the impact.

15. A shock absorbing device comprising,
a first contiguous membrane defining a first primary liquid reservoir containing a liquid, the first contiguous membrane including at least one collapsible feature; and
a second contiguous membrane surrounding the first contiguous membrane and defining a first secondary liquid reservoir fluidly connected to the first primary liquid reservoir through a first orifice, the second contiguous membrane being impermeable; and
and an exterior sleeve surrounding the first contiguous membrane and the second contiguous membrane,
wherein in a first state, the first contiguous membrane is in an expanded position and in a second state the first contiguous membrane is in a compressed position, and
wherein the first contiguous membrane is compressible upon an impact thereby transferring the liquid from the first primary liquid reservoir through the orifice to the first secondary liquid reservoir and dissipating the impact.

16. The shock absorbing device of claim 15, further comprising a support structure disposed between the second contiguous membrane and the exterior sleeve, wherein the support structure defines an aperture therethrough, and wherein the second contiguous membrane is at least partially received in the aperture.

17. The shock absorbing device of claim 15, further comprising a plate disposed between the second contiguous membrane and the exterior sleeve, wherein the plate is configured to transfer impact energy to the first contiguous membrane.

18. The shock absorbing device of claim 15, further comprising a plate disposed between the first contiguous membrane and the second contiguous membrane, wherein the plate is configured to transfer impact energy to the first contiguous membrane.

19. The shock absorbing device of claim 15, wherein the at least one collapsible feature is (i) a plurality of bellows, (ii) a plurality of discrete steps, or (iii) a buckle point of the first contiguous membrane.

20. The shock absorbing device of claim 15, further comprising:
a third contiguous membrane defining a second primary liquid reservoir containing a liquid, the third contiguous membrane including at least one collapsible feature, the third contiguous membrane being compressible from an expanded state and a compressed state; and
a fourth contiguous membrane surrounding the third contiguous membrane and defining a second secondary liquid reservoir fluidly connected to the second primary liquid reservoir through a second orifice; and
a plate disposed within the exterior sleeve and configured to transfer an impact load to both the first contiguous membrane and the third contiguous membrane,
wherein the third contiguous membrane is compressible upon the impact thereby transferring the liquid from the second primary liquid reservoir through the second orifice to the second secondary liquid reservoir and dissipating the impact, and
wherein the exterior sleeve surrounds the third contiguous membrane and the fourth contiguous membrane.
